(19) United States
(12) Patent Application Publication
(10) Pub. No.: US 2020/0326722 A1
(43) Pub. Date: Oct. 15, 2020

(54) MOBILE ROBOT, SYSTEM FOR MULTIPLE MOBILE ROBOT, AND MAP LEARNING METHOD OF MOBILE ROBOT USING ARTIFICIAL INTELLIGENCE

(71) Applicant: LG ELECTRONICS INC., Seoul (KR)

(72) Inventors: Seungwook LIM, Seoul (KR); Taekyeong LEE, Seoul (KR); Dongki NOH, Seoul (KR)

(21) Appl. No.: 16/096,650

(22) PCT Filed: Apr. 25, 2017
(86) PCT No.: PCT/KR2017/004390

§ 371 Date: Oct. 25, 2018

(30) Foreign Application Priority Data
Apr. 25, 2016 (KR) 10-2016-0050212

(51) Int. Cl. G05D 1/02; B25J 9/00; B25J 11/00

(52) U.S. Cl. CPC G05D 1/0274; G05D 1/0221; G05D 2201/0203; B25J 9/0003; B25J 11/0085; G05D 1/0219

(57) ABSTRACT

The present invention relates to a technology in which a moving robot using artificial intelligence is enabled to learn a map using information generated by itself and information received from another moving robot, and a map learning method of a moving robot according to the present invention includes generating, by the moving robot, node information based on a constraint measured during traveling, and receiving node group information of another moving robot. A moving robot using artificial intelligence according to the present invention includes: a travel drive unit configured to move a main body; a travel constraint measurement unit configured to measure a travel constraint; a receiver configured to receive node group information of another moving robot; and a controller configured to generate node information on a map based the travel constraint, and add the node group information of the another moving robot to the map.

### TECHNICAL FIELD

The present invention relates to a moving robot, a system for a plurality of moving robots, and a map learning method of the moving robot, and more particularly to a technology by which a moving robot learns a map using information generated by itself and information received from another moving robot.

### BACKGROUND ART

In general, robots have been developed for an industrial purpose and have been in charge of part of factory automation. Recently, robot-applied fields have further extended to develop medical robots or aerospace robots, and household robots that may be used in ordinary homes have also been made. Among these robots, robots capable of traveling on its own are referred to as moving robots.

A typical example of the moving robots used at home is a robot cleaner which is a home appliance capable of moving in a travel area to be cleaned in a way of suctioning dust or foreign substances for cleaning. The robot cleaner has a rechargeable battery and thus is enabled to travel on its own, and, when the battery is run out or after cleaning is completed, the robot cleaner finds a charging base and moves to the charging base on its own to charge the battery.

In related arts, various method of constantly recognizing a current position based on previous position information during continuous travel of a moving robot and generating a map of a travel area on its own have been already well known.

For reasons including a wide travel area, two or more moving robot may travel in the same indoor space.

In a related art (Korean Patent Application Publication No. 10-2013-0056586) discloses a technology of measuring a relative distance between a plurality of moving robots, separating areas and searching for area information by each of the plurality of moving robots based on the measured relative distance, and then transmitting the found area information to another moving robot.

### RELATED ART DOCUMENT

### Patent Document

Korean Patent Application Publication No. 10-2013-0056586 (Publication Date: May 30, 2013)

### DISCLOSURE

### Technical Problem

A first object of the present invention is to provide a technology of efficiently performing map learning by combining information of a plurality of moving robots when the plurality of moving robots travels in the same travel space.

In the above related art, it is difficult for moving robots to measure a distance relative to each other for the reasons of a distance or an obstacle.

A second object of the present invention is to provide a technology of efficiently separating a search area without measuring a relative distance between moving robots by solving the above problem.

In the above related art, moving robots separates area based on a measured relative distance therebetween, and, in this case, if a corresponding travel area has a complex shape or a position of one moving robot is at a corner in the travel area, efficient area separation is not possible. A third object of the present invention is to provide a technology of automatically and efficiently distributing search areas by first learning a travel area, rather than first separating the area and then searches for an area.

A fourth object of the present invention is to provide a technology of continuously and highly accurately estimating map learning information, generated by a moving robot.

In the above related art, each moving robot shares information found on its own ad there is no disclosure of a technology of enabling moving robots to be informed each other's information more accurately. A fifth object of the present invention is to provide a technology of enabling a plurality of robots to learn a map, share each other's map, and highly accurately modify map learning information of its own and each other.

Objects of the present invention should not be limited to the aforementioned objects and other unmentioned objects will be clearly understood by those skilled in the art from the following description.

### Technical Solution

To achieve the first to third objects, a map learning method of a moving robot according to the present invention includes: generating by a generating, by the moving robot, node information based on a constraint measured during traveling; and receiving node group information of another moving robot.

Information on nodes on a map of one moving robot is comprised of node information generated by the moving robot and the node group information of the another moving robot.

The node information may include node unique index, information on a corresponding acquisition image, information on a distance to a surrounding environment, node coordinate information, and node update time information.

The node group information of the another moving robot may be a set of node information in all node information stored in the another moving robot, except all node information generated by the another moving robot.

In order to achieve the same objects even in the another moving robot and further enhance efficiency of map learning of the moving robot, the learning method may include transmitting the node group information of the moving robot to the another moving robot.

To achieve the fourth object, the learning method may include: measuring a loop constraint between two nodes generated by the moving robot; and modifying coordinates of the nodes, generated by the moving robot, on a map based on the measured loop constraint.

To achieve the fifth object, the learning method may include measuring an edge constraint between a node generated by the moving robot and a node generated by the another moving robot. The learning method may include aligning coordinates of a node group, received from the another moving robot, on a map based on the measured edge constraint, or modifying coordinates of the node generated by the moving robot on a map based on the measured edge constraint.

In order to efficiently achieve the fifth object, an algorithm of selecting either alignment or modification may be implemented. To this end, the learning method may include: aligning coordinates of a node group received from the another moving robot on a map based on the measured edge constraint, and, when the coordinates of the node group received from the another moving robot is pre-aligned on the map, modifying the coordinates of the node generated by the moving robot on the map based on the measured edge constraint.

The present invention may be specified mainly about an interacting process of a plurality of robots to achieve the first to fifth object. A map learning method of a moving robot according to another embodiment of the present invention includes: generating, by a plurality of moving robots, node information of each of the plurality of moving robots based on constraint measured during traveling; and transmitting and receiving node group information of each of the plurality of moving robots with one another.

To achieve the fifth object, the learning method may include: measuring an edge constraint between two nodes respectively generated by the plurality of moving robots; and aligning coordinates of a node group received from the other moving robot on a map of one moving robot based on the measured edge constraint, and aligning coordinates of a node group received from one moving robot on a map of the other moving robot based on the measured edge constraint.

To achieve the fifth object, the learning method may include: modifying coordinates of a node generated by one moving robot on a map of one moving robot based on the measured edge constraint, and modifying coordinates of a node generated by the other moving robot on a map of the other moving robot based on the measured edge constraint.

In order to efficiently achieve the fifth object, an algorithm of selecting either alignment or modification may be implemented. To this end, the learning method may include, when coordinates of a node group received from the other moving robot is not pre-aligned on a map, aligning coordinates of a node group received from the other moving robot on a map of one moving robot based on the measured edge constraint and aligning coordinates of a node group received from one moving robot on a map of the other moving robot based on the measured edge constraint. In addition, the learning method may include, when the coordinates of the node group received from the other moving robot is pre-aligned on the map, modifying coordinates of a node generated by one moving robot on the map of one moving robot based on the measured edge constraint and modifying coordinates of a node generated by the other moving robot on the map of the other moving robot based on the measured edge constraint.

To achieve the fourth and fifth object, the node information may include information on each node, and, when wherein the information on each node comprises node update time information, and, when received node information and stored node information are different with respect to an identical node, latest node information may be selected based on the node update time information.

In an embodiment in which the plurality of moving robot is three or more moving robots, in order to achieve the fourth and fifth objects, node group information received by a first moving robot from a second moving robot may include node group information received by the second moving robot from a third moving robot, and, even in this case, latest node information may be selected based on the node update time information.

A program of implementing the learning method may be implemented, and a computer readable recording medium which records the program may be implemented.

Each process of the present invention may be implemented in different moving robots, a center server, or a computer, but may be implemented by each element of one moving robot. To achieve the first to fifth object, a moving robot according to the present invention includes: a travel drive unit configured to move a main body; a travel constraint measurement unit configured to measure a travel constraint; a receiver configured to receive node group information of another moving robot; and a controller configured to generate node information on a map based the travel constraint, and add the node group information of the another moving robot to the map. The moving robot may include a transmitter configured to transmit node group information of the moving robot to the another moving robot. The controller may include a node information generation module, a node information modification module, and a node group coordinate alignment module.

The present invention may be specified mainly about a system for a plurality of moving robots to achieve the first to fifth objects. In a system for a plurality of moving robots including a first moving robot and a second moving robot according to the present invention, the first moving robot includes: a first travel drive unit configured to move the first moving robot; a first travel constraint measurement unit configured to measure a travel constraint of the first moving robot; a first receiver configured to receive node group information of the second moving robot; a first transmitter configured to transmit node group information of the first moving robot to the second moving robot; and a first controller configured to generate node information on a first map based on the travel constraint of the first moving robot, and add the node group information of the second moving robot to the first map. In addition, the second moving robot includes: a second travel drive unit configured to move the second moving robot; a second travel constraint measurement unit configured to measure a travel constraint of the second moving robot; a second receiver configured to receive the node group information of the first moving robot; a second transmitter configured to transmit the node group information of the second moving robot to the second moving robot; and a second controller configured to generate node information to a second map based on the travel constraint of the second moving robot, and add the node group information of the first moving robot to the second map.

As such, each element of the first moving robot and the second moving robot may be distinguished using the terms “first,” “second,” etc. The first controller may include a first node generation module, a first node information modification module, and a first node group coordinate modification module. The second controller may include a second node generation module, a second node information modification module, and a second node group coordinate modification module.

The details of other embodiments are included in the following description and the accompanying drawings.

### Advantageous Effects

Through the above solutions, a map may be efficiently and accurately learned when a plurality of moving robots travels in the same travel space.

In addition, unlike the related art, search area may be separated without measurement of a relative distance between moving robots.

In addition, any possibility of inefficient distribution of search areas occurring when the search areas are separated in an initial stage may be removed, and efficiency of search area separation is remarkably enhanced as and the search areas are divided as a result of learning a map without area separation.

In addition, efficiency of a map learning process may be induced to remarkably increase in proportion of the number of moving robots.

In addition through a process of sharing map information by a plurality of moving robots with each other to reduce an error, accuracy of a learned map may be remarkably enhanced.

Effects of the present invention should not be limited to the aforementioned effects and other unmentioned effects will be clearly understood by those skilled in the art from the claims.

### DESCRIPTION OF DRAWINGS

FIG. 1 is a perspective view illustrating a moving robot and a charging base for the moving robot according to an embodiment of the present invention.

FIG. 2 is a view illustrating a top part of the robot cleaner illustrated in FIG.

FIG. 3 is a view illustrating a front part of the robot cleaner illustrated in FIG. 1.

FIG. 4 is a view illustrating a bottom part of the robot cleaner illustrated in FIG. 1.

FIG. 5 is a block diagram illustrating a control relationship between major components of a moving robot according to an embodiment of the present invention.

FIG. 6 is a flowchart illustrating a map learning process and a process of recognizing a position on a map by a moving robot according to an embodiment of the present invention.

FIG. 7 is a plan conceptual view illustrating a plurality of areas A1, A2, A3, A4, and A5 and a travel area X comprised of the plurality of areas A1, A2, A3, A4, and A5 according to an embodiment.

FIG. 8 exemplarily illustrates a plurality of areas A1 and A2 in a travel area X according to an embodiment, and images respectively acquired at a plurality of positions (nodes) A1p1, A1p2, A1p3, A1p4, A2p1, A2p1, A2p1, and A2p1 in the respective areas A1 and A2.

FIG. 9 is a diagram illustrating features f1, f2, f3, f4, f5, f6, and f7 in an image acquired from a position A1p1 in FIG. 8.

FIG. 10 is a conceptual diagram illustrating how to calculate descriptors \vec{F1}, \vec{F2}, \vec{F3}, . . . , \vec{Fm} which are n-dimensional vectors respectively corresponding to all features f1, f2, f3, . . . , and fm in an area A1 according to an embodiment.

FIG. 11 illustrates how to classify the plurality of descriptors \vec{F1}, \vec{F2}, \vec{F3}, . . . , \vec{Fm} calculated in an area A1 through the process of FIG. 10 into a plurality of groups A1G1, A1G2, A1G3, . . . , and A1GI by a predetermined classification rule, and how to convert a plurality of descriptors included in the same group into respective descriptors by \vec{AlF1}, \vec{A1F2}, \vec{A1F3}, . . . , \vec{A1Fl} a predetermined representation rule.

FIG. 12 illustrates a histogram of an area A1 with a score s increasing in proportion of the number w of respective descriptors \vec{A1F1}, \vec{A1F2}, \vec{A1F3}, . . . , \vec{A1Fl}, and is a diagram for visually illustrating a feature distribution of an area A1.

FIG. 13 is a diagram illustrating recognition features h1, h2, h3, h4, h5, h6, and h7 in an image acquired at an unknown current position.

FIG. 14 is a conceptual diagram illustrating how to calculate recognition descriptors (\vec{H1}, \vec{H2}, \vec{H3}, \vec{H4}, \vec{H5}, \vec{H6}, \vec{H7}) which are n-dimensional vectors respectively corresponding to all recognition features h1, h2, h3, h4, h5, h6, and h7 in an image acquired in FIG. 13.

FIG. 15 is a conceptual diagram illustrating how to convert the recognition descriptors in FIG. 14 into representative descriptors \vec{A1F1}, \vec{A1F2}, . . . , \vec{A1Fl}: of a comparison subject area A1 to calculate a recognition feature distribution of the comparison subject area A1. In order to visually show a recognition feature distribution, a histogram is illustrated with a recognition score Sh which increases in proportion to the number wh of representative descriptors.

FIG. 16 is a conceptual diagram illustrating how to compare a recognition feature distribution of each area calculated through the process of FIG. 15 and a corresponding area feature distribution by a predetermined comparison rule to compare a probability therebetween and select any one area.

FIG. 17 is a flowchart illustrating a process (S100) in which only one moving robot learns a map while traveling in a travel area, according to a first embodiment.

FIG. 18 is a block diagram illustrating information items which constitute node (N) information according to a first embodiment of FIG. 17, and information which influences the node (N) information.

FIG. 19 is a diagram illustrating a node N generated while one moving robot travels according to the first embodiment of FIG. 17, and a constraint between nodes.

FIG. 20 is a flowchart illustrating a process (S200) in which a plurality of moving robot learns maps while traveling in a travel area, according to a second embodiment.

FIG. 21 is a block diagram information items which constitute node (N) information according to the second embodiment of FIG. 20, information which influences the node (N) information, and information which influences node information of another moving robot.

FIGS. 22 to 24 illustrates nodes N generated by a plurality of moving robot during traveling according to the second embodiment of FIG. 20, a constraint C between nodes, and a map learned by a moving robot A. FIG. 22 is a diagram illustrating a state in which coordinates of a node group GB of a moving robot B have yet to be aligned on a map learned by the moving robot A, FIG. 23 is a diagram illustrating a state in which coordinates of the node group GB of the moving robot B are aligned on the map learned by the moving robot A as an edge constraint EC1 between nodes is measured, and FIG. 24 is a diagram illustrating a state in which node (N) information is modified on the map learned by the moving robot A as additional edge constraints EC2 and EC3 between nodes are measured.

FIG. 25 is a diagram illustrating nodes N generated by three moving robots during traveling, constraints C between nodes, loops constraints A-LC1, B-LC1, and C-LC1 between nodes, edge constraints AB-EC1, BC-EC1, BC-EC2, CA-EC1, and CA-EC2 between nodes, and a map learned by the moving robot A.

FIGS. 26A to 26F are diagrams illustrating a scenario of generating a map by a moving robot 100a and another moving robot 100b in cooperation and utilizing the map, the diagrams in which actual positions of the moving robots 100a and 100b and a map learned by the moving robot 100a are shown.

### BEST MODE

Advantages and features of the present invention and a method of achieving the same will be clearly understood from embodiments described below in detail with reference to the accompanying drawings. However, the present invention is not limited to the following embodiments and may be implemented in various different forms. The embodiments are provided merely for complete disclosure of the present invention and to fully convey the scope of the invention to those of ordinary skill in the art to which the present invention pertains. The present invention is defined only by the scope of the claims. In the drawings, the thickness of layers and areas may be exaggerated for clarity. Throughout the drawings, like numbers refer to like elements.

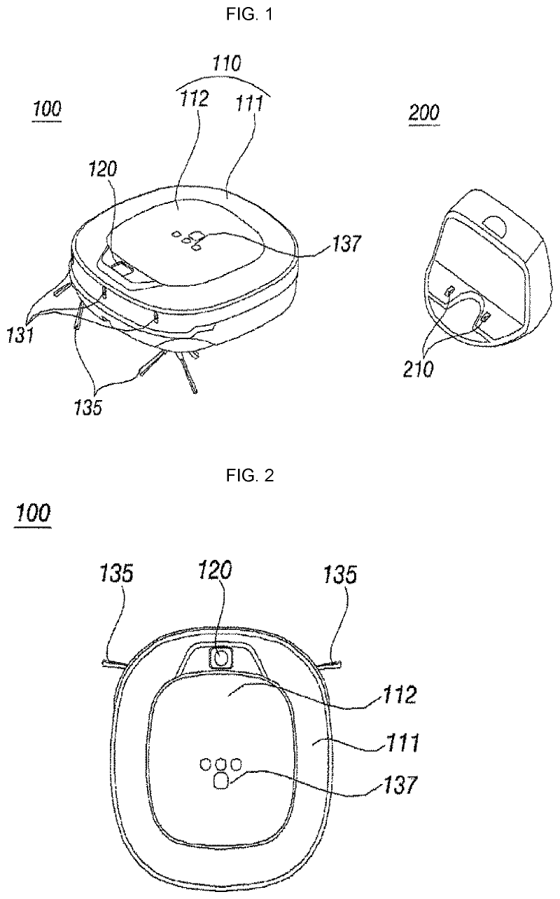

A moving robot 100 of the present invention refers to a robot capable of moving by itself with a wheel and the like, and the moving robot 100 may be a domestic robot and a robot cleaner. Hereinafter, with reference to FIGS. 1 to 4, the moving robot 100 is exemplified by a robot cleaner 100 but not necessarily limited thereto.

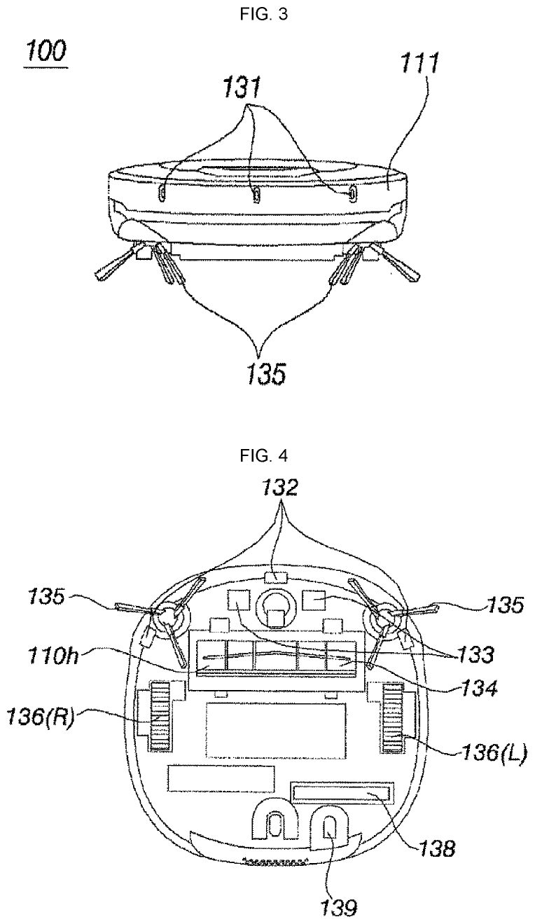

FIG. 1 is a perspective view illustrating a cleaner 100 and a charging base 200 for charging a moving robot. FIG. 2 is a view illustrating a top part of the robot cleaner 100 illustrated in FIG. 1. FIG. 3 is a view illustrating a front part of the robot cleaner 100 illustrated in FIG. 1. FIG. 4 is a view illustrating a bottom part of the robot cleaner 100 illustrated in FIG. 1.

The robot cleaner 100 includes a main body 110, and an image acquisition unit 120 for acquiring an image of an area around the main body 110. Hereinafter, as to defining each part of the main body 110, a part facing the ceiling in a cleaning area is defined as a top part (see FIG. 2), a part facing the floor in the cleaning area is defined as a bottom part (see FIG. 4), and a part facing a direction of travel in parts constituting the circumference of the main body 110 between the top part and the bottom part is referred to as a front part (see FIG. 3).

The robot cleaner 100 includes a travel drive unit 160 for moving the main body 110. The travel drive unit 160 includes at least one drive wheel 136 for moving the main body 110. The travel drive unit 160 may include a driving motor. Drive wheels 136 may be provided on the left side and the right side of the main body 110, respectively, and such drive wheels 136 are hereinafter referred to as a left wheel 136(L) and a right wheel 136(R), respectively.

The left wheel 136(L) and the right wheel 136(R) may be driven by one driving motor, but, if necessary, a left wheel drive motor to drive the left wheel 136(L) and a right wheel drive motor to drive the right wheel 136(R) may be provided. The travel direction of the main body 110 may be changed to the left or to the right by making the left wheel 136(L) and the right wheel 136(R) have different rates of rotation.

A suction port 110h to suction air may be formed on the bottom part of the body 110, and the body 110 may be provided with a suction device (not shown) to provide suction force to cause air to be suctioned through the suction port 110h, and a dust container (not shown) to collect dust suctioned together with air through the suction port 110h.

The body 110 may include a case 111 defining a space to accommodate various components constituting the robot cleaner 100. An opening allowing insertion and retrieval of the dust container therethrough may be formed on the case 111, and a dust container cover 112 to open and close the opening may be provided rotatably to the case 111.

There may be provided a roll-type main brush having bristles exposed through the suction port 110h and an auxiliary brush 135 positioned at the front of the bottom part of the body 110 and having bristles forming a plurality of radially extending blades. Dust is removed from the floor in a cleaning area by rotation of the brushes 134 and 135, and such dust separated from the floor in this way is suctioned through the suction port 110h and collected in the dust container.

A battery 138 serves to supply power not only necessary for the drive motor but also for overall operations of the robot cleaner 100. When the battery 138 of the robot cleaner 100 is running out, the robot cleaner 100 may perform return travel to the charging base 200 to charge the battery, and during the return travel, the robot cleaner 100 may autonomously detect the position of the charging base 200.

The charging base 200 may include a signal transmitting unit (not shown) to transmit a predetermined return signal. The return signal may include, but is not limited to, a ultrasonic signal or an infrared signal.

The robot cleaner 100 may include a signal sensing unit (not shown) to receive the return signal. The charging base 200 may transmit an infrared signal through the signal transmitting unit, and the signal sensing unit may include an infrared sensor to sense the infrared signal. The robot cleaner 100 moves to the position of the charging base 200 according to the infrared signal transmitted from the charging base 200 and docks with the charging base 200. By docking, charging of the robot cleaner 100 is performed between a charging terminal 133 of the robot cleaner 100 and a charging terminal 210 of the charging base 200.

The image acquisition unit 120, which is configured to photograph the cleaning area, may include a digital camera. The digital camera may include at least one optical lens, an image sensor (e.g., a CMOS image sensor) including a plurality of photodiodes (e.g., pixels) on which an image is created by light transmitted through the optical lens, and a digital signal processor (DSP) to construct an image based on signals output from the photodiodes. The DSP may produce not only a still image, but also a video consisting of frames constituting still images.

Preferably, the image acquisition unit 120 is provided to the top part of the body 110 to acquire an image of the ceiling in the cleaning area, but the position and capture range of the image acquisition unit 120 are not limited thereto. For example, the image acquisition unit 120 may be arranged to acquire a forward image of the body 110. The present invention may be implementable only with an image of a ceiling.

In addition, the robot cleaner 100 may further include an obstacle sensor to detect a forward obstacle. The robot cleaner 100 may further include a sheer drop sensor 132 to detect presence of a sheer drop on the floor within the cleaning area, and a lower camera sensor 139 to acquire an image of the floor.

In addition, the robot cleaner 100 includes a manipulation unit 137 to input an on/off command or any other various commands.

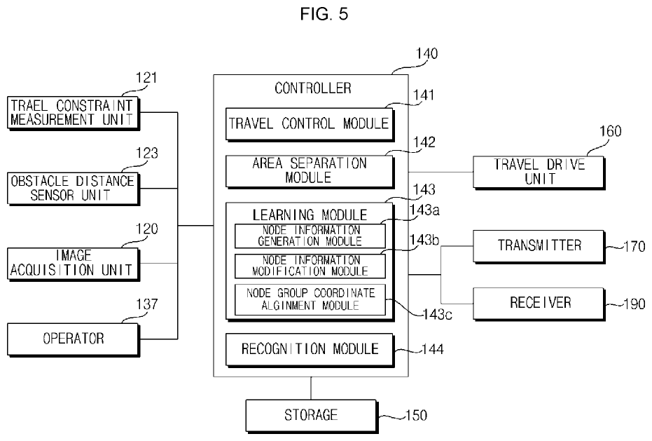

Referring to FIG. 5, the moving robot 100 may include a controller 140 for processing and determining a variety of information, such as recognizing the current position, and a storage 150 for storing a variety of data. The controller 140 controls overall operations of the moving robot 100 by controlling various elements (e.g., a travel constraint measurement unit 121, an object detection sensor 131, an image acquisition unit 120, a manipulation unit 137, a travel drive unit 160, a transmitter 170, a receiver 190, etc.) included in the moving robot 100, and the controller 140 may include a travel control module 141, an area separation module 142, a learning module 143, a recognition module 144.

The storage 150 serves to record various kinds of information necessary for control of the moving robot 100 and may include a volatile or non-volatile recording medium. The recording medium serves to store data which is readable by a micro processor and may include a hard disk drive (HDD), a solid state drive (SSD), a silicon disk drive (SDD), a ROM, a RAM, a CD-ROM, a magnetic tape, a floppy disk, and an optical data storage.

Meanwhile, a map of the cleaning area may be stored in the storage 150. The map may be input by an external terminal capable of exchanging information with the moving robot 100 through wired or wireless communication, or may be constructed by the moving robot 100 through self-learning. In the former case, examples of the external terminal may include a remote control, a PDA, a laptop, a smartphone, a tablet, and the like in which an application for configuring a map is installed.

On the map, positions of rooms in a travel area may be marked. In addition, the current position of the robot cleaner 100 may be marked on the map, and the current position of the moving robot 100 on the map may be updated during travel of the robot cleaner 100.

The controller 140 may include the area separation module 142 for separating a travel area X into a plurality of areas by a predetermined criterion. The travel area X may be defined as a range including areas of every plane previously traveled by the moving robot 100 and areas of a plane currently traveled by the moving robot 100.

The areas may be separated on the basis of rooms in the travel area X.

The area separation module 142 may separate the travel area X into a plurality of areas completely separated from each other by a moving line. For example, two indoor spaces completely separated from each other by a moving line may be separated as two areas. In another example, even in the same indoor space, the areas may be separated on the basis of floors in the travel area X.

The controller 140 may include the learning module 143 for generating a map of the travel area X. For global location recognition, the learning module 143 may process an image acquired at each position and associate the image with the map.

The travel constraint measurement unit 121 may be, for example, the lower camera sensor 139. When the moving robot 100 continuously moves, the travel constraint measurement unit 121 may measure a travel constraint through continuous comparison between different floor images using pixels. The travel constraint is a concept including a moving direction and a moving distance. When it is assumed that a floor of a travel area is on a plane where the X-axis and the Y-axis are orthogonal to each other, the travel constraint may be represented as (Δx,Δy,θ), wherein Δx,Δy indicate constraint on the X-axis and the Y-axis, respectively, and θ indicates a rotation angle.

The travel control module 141 serves to control traveling of the moving robot 100, and controls driving of the travel drive unit 160 according to a travel setting. In addition, the travel control module 141 may identify a moving path of the moving robot 100 based on operation of the travel drive unit 160. For example, the travel control module 141 may identify a current or previous moving speed, a distance traveled, etc. of the moving robot 100 based on a rotation speed of a driving wheel 136, and may also identify a current or previous switch of direction in accordance with a direction of rotation of each drive wheel 136(L) or 136(R). Based on travel information of the moving robot 100, which is identified in the above manner, a position of the moving robot 100 on a map may be updated.

The moving robot 100 measure the travel constraint using at least one of the travel constraint measurement unit 121, the travel control module 141, the object detection sensor 131, or the image acquisition unit 125. The controller 140 includes a node information generating module 143a for generating information on each node N, which will be described later on, on a map based on the travel constraint information. For example, using the travel constraint measured with reference to an origin node O which will be described later on, coordinates of a generated node N may be generated. The coordinates of the generated node N are coordinate values relative to the origin node O. Information on the generated node N may include corresponding acquisition image information. Throughout this description, the term “correspond” means that a pair of objects (e.g., a pair of data) is matched with each other such that, if one of them is input, the other one is output. For example, in the case where an acquisition image acquired at a position when the position is input or in the case where a position, at which any one acquisition image acquired, is output when the any one acquisition image is input, this may be expressed such that the ay one acquisition image and the any one position “correspond” to each other.

The moving robot 100 may generate a map of an actual travel area based on the node N and a constraint between nodes. The node N indicates a point on a map, which is data converted from information on an actual one point. That is, each actual position corresponds to a node on a learned map, an actual position and a node on the map may have an error rather than matching, and generating a highly accurate map by reducing such an error is one of objects of the present invention. Regarding a process for reducing the error, a loop constraint LC and an edge constraint EC will be described later on.

The moving robot 100 may measure an error in node coordinate information D186 out of pre-generated information D180 on a node N, by using at least one of the object detection sensor 131 or the image acquisition unit 125. (See 18 and 21) The controller 140 includes a node information modifying module 143b for modifying information on each node N generated on a map, based on the measured error in the node coordinate information.

For example, the information D180 on any one node N1 generated based on the travel constraint includes node coordinate information D186, and acquisition image information D183 corresponding to the corresponding node N1, and, if acquisition image information D183 corresponding to another node N2, generated around the corresponding node N1, out of information on the node N2 is compared with the acquisition image information D183 corresponding to the node N1, a constraint (a loop constraint LC or a edge constraint EC which will be described later on) between the two nodes N1 and N2 is measured. In this case, if there is a difference between the constraint (the loop constraint LC or the edge constraint EC) measured through comparison of acquisition image information and a constraint measured through the pre-stored coordinate information D186 of the two nodes N1 and N2, the coordinate information D186 of the two nodes may be modified as the difference is regarded as an error. In this case, coordinate information D186 of other nodes connected to the two nodes N1 and N2 may be modified. In addition, even previously modified coordinate information D186 may be modified repeatedly through the above process. Detailed description thereof will be provided later on.

When a position of the moving robot 100 is artificially jumped, the current position is not allowed to be recognized based on the travel information. The recognition module 144 may recognize an unknown current position using at least one of the obstacle detection sensor 131 or the image acquisition unit 125. Hereinafter, a process for recognizing an unknown current position using the image acquisition unit will be exemplified, but aspects of the present invention are not limited thereto.

The transmitter 170 may transmit information on the moving robot to another moving robot or a central server. The information transmitted by the transmitter 170 may be information on a node N of the moving robot or information on a node group M which will be described later on.

The receiver 190 may receive information on another moving robot from the another moving robot or the central server. The information received by the receiver 190 may be information on a node N of the moving robot or information on a node group M which will be described later on.

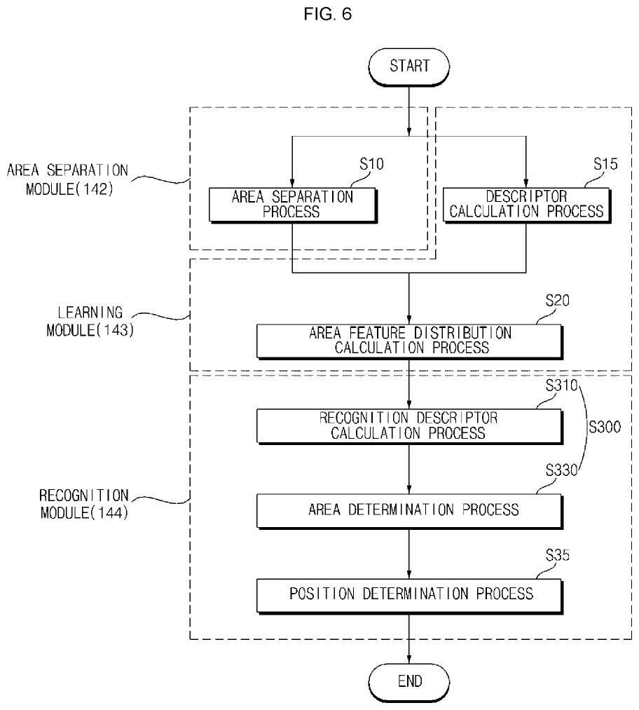

Referring to FIGS. 6 to 15, a moving robot, which learns a travel area using an acquired image, stores a map of the learned travel area, and estimates an unknown current position using an image acquired at the unknown current position in a situation such as a position jumping event, and a control method of the moving robot according to one embodiment is described as follows.

The control method according to the one embodiment includes: an area separation process (S10) of separating a travel area X into a plurality of areas by a predetermined criterion; a learning process for learns the travel area to generate a map; and a recognition process for determining an area, in which a current position is included, on the map. The recognition process may include a process for determining the current position. The area separation process (S10) and the learning process may be partially performed at the same time. Throughout this description, the term “determine” does not mean determining by a human, but selecting any one by the controller of the present invention or a program, which implements the control method of the present invention, using a predetermined rule. For example, if the controller selects one of a plurality of small areas using a predetermined estimation rule, this may be expressed such that a small area is “determined”. The meaning of the term “determine” is a concept including not just selecting any one of a plurality of subjects, but also selecting only one subject which exists alone.

The area separation process (S10) may be performed by the area separation module 142, the learning process may be performed by the learning module 143, and the recognition process may be performed by the recognition module 144.

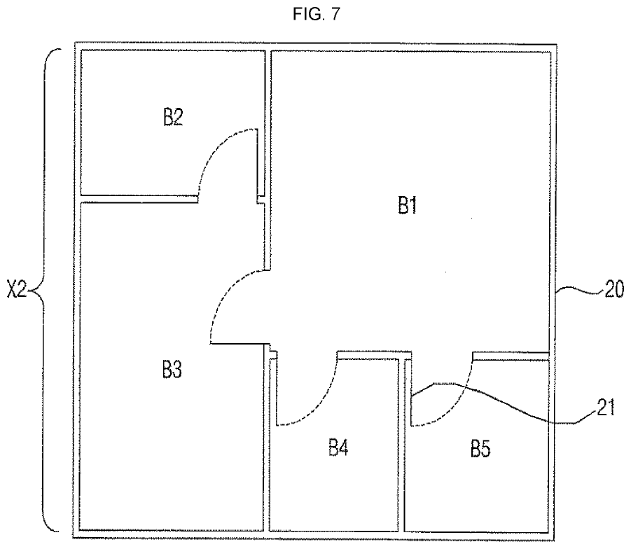

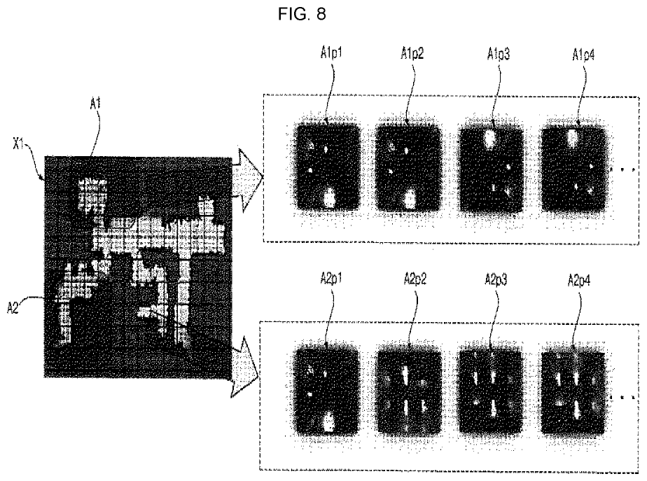

In the area separation process (S10), the travel area X may be separated into a plurality of areas by a predetermined standard. Referring to FIG. 7, the areas may be classified on the basis of rooms A1, A2, A3, A4, and A5 in the travel area X. In FIG. 8, the respective rooms A1, A2, A3, A4, and A5 are separated by wall 20 and an openable doors 21. As described above, the plurality of areas may be separated on the basis of floors or on the basis of spaces separated by a moving path. In another example, the travel area may be separated into a plurality of large areas, and each large area may be separated into a plurality of small areas.

Referring to FIG. 11, each area A1 or A2 is composed of a plurality of positions constituting a corresponding area. Among them, a position having acquisition information and coordinate information, which correspond to each other, may be defined as a node N on a map. An area A1 may include a plurality of positions (nodes) A1p1, A1p2, A1p3, . . . , A1pn (n is a natural number).

A process for learning a map and associating the map with data (feature data) obtained from an acquisition image acquired at each node N (an acquisition image corresponding to each node N) is described as follows.

The learning process includes a descriptor calculation process (S15) of acquiring images at a plurality of positions (nodes on a map) in each of the areas, extracting features from each of the images, and calculating descriptors respectively corresponding to the features. The descriptor calculation process (S15) may be performed at the same time with the area separation process (S10). Throughout this description, the term “calculate” means outputting other data using input data, and include the meaning of “obtaining other data as a result of calculating input numerical data”. Of course, the number of input data and/or calculated data may be a plurality of data.

While the moving robot 100 travels, the image acquisition unit 120 acquires images of the surroundings of the moving robot 100. The images acquired by the image acquisition unit 120 are defined as “acquisition images”. The image acquisition unit 120 acquires an acquisition image at each position on a map.

Referring to FIG. 8, at each node (e.g., A1p1, A1p2, A1p3, . . . , A1pn), an acquisition corresponding thereto exists. Information D180 on each node, including information D183 on a corresponding acquisition image, is stored in the storage 150.

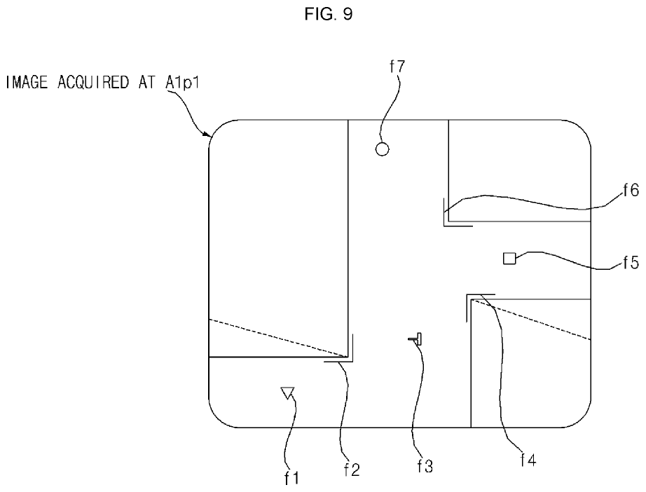

FIG. 9 illustrates an acquisition image captured at a certain position in a travel area, and various features, such as lighting devices, edges, corners, blobs, and ridges which are placed on a ceiling, are found in the image.

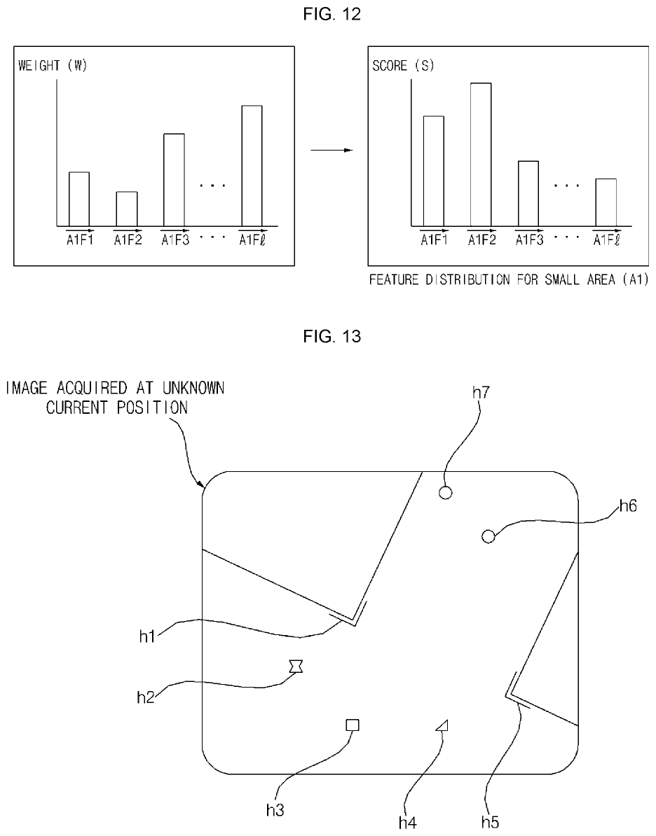

The learning module 143 detects features (e.g., f1, f2, f3, f4, f5, f6, and f7 in FIG. 12) from each acquisition image. In the computer vision field, various feature detection methods for detecting a feature from an image are well-known. A variety of feature detectors suitable for such feature detection are well known. For example, there are Canny, Sobel, Harris & Stephens/Plessey, SUSAN, Shi & Tomasi, Level curve curvature, FAST, Laplacian of Gaussian, Difference of Gaussians, Determinant of Hessian, MSER, PCBR, and Grey-level blobs detectors.

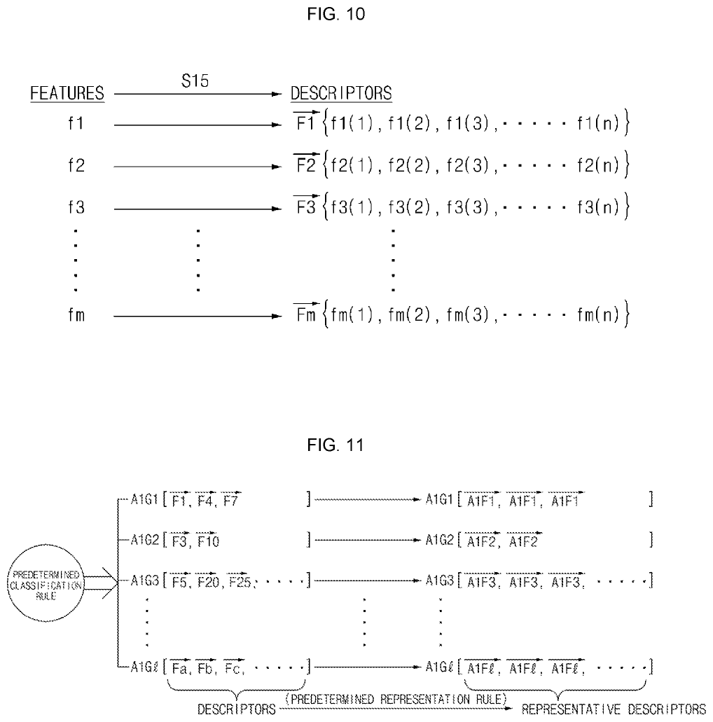

FIG. 10 is a diagram illustrating calculating descriptors based on features f1, f2, f3, . . . , and fm through a descriptor calculation process (S15). (m is a natural number). For feature detection, the features f1, f2, f3, . . . , and fm may be converted into descriptors using Scale Invariant Feature Transform (SIFT). Throughout this description, the term “convert” means changing any one data into another data.

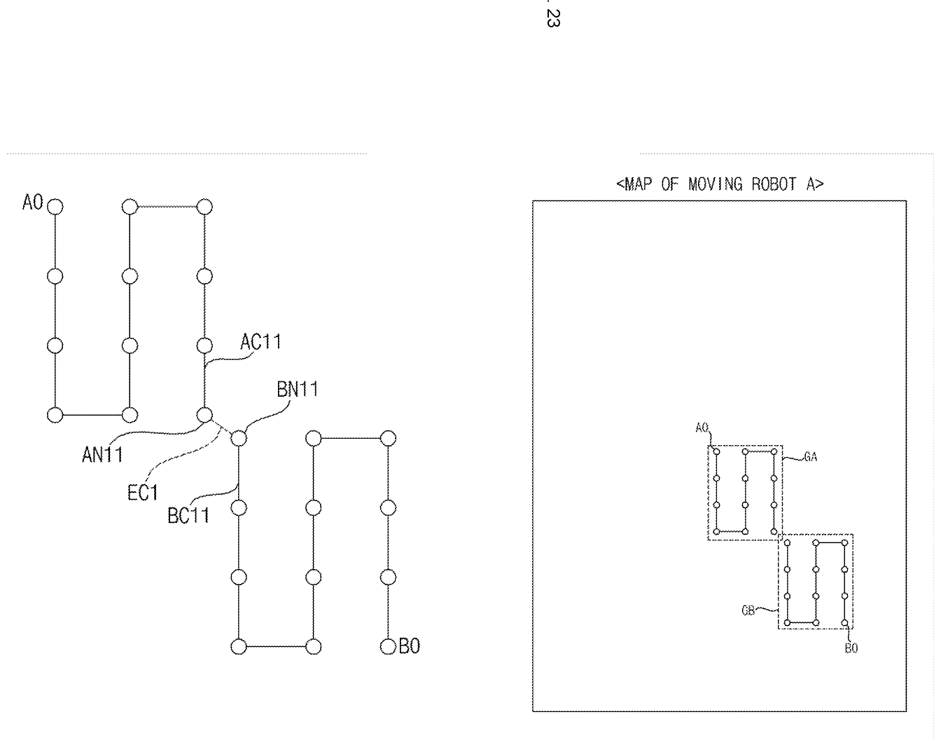

The descriptors may be represented as n-dimensional vectors. (n is a natural number) In FIG. 21, \vec{F1}, \vec{F2}, \vec{F3}, . . . , \vec{Fm} indicates n-dimensional vector. f1(1), f1(2), f1(3), . . . , f1(n) within the brace \vec{F1} of respectively indicate values of dimensions that constitute \vec{F1}. The remaining \vec{F2}, \vec{F3}, . . . , \vec{Fm} are represented in the same way and detailed description thereof is herein omitted.

For example, the SIFT is an image recognition technique by which easily distinguishable features f1, f2, f3, f4, f5, f6, and f7, such as corners, are selected in an acquisition image of FIG. 9 and n-dimensional vectors are obtained, which are values of dimensions indicative of a drastic degree of change in each direction with respect to a distribution feature (a direction of brightness change and a drastic degree of the change) of gradient of pixels included in a predetermined area around each of the features f1, f2, f3, f4, f5, f6, and f7.

The SIFT enables detecting a feature invariant to a scale, rotation, change in brightness of a subject, and thus, it is possible to detect an invariant (i.e., rotation-invariant) feature of an area even when images of the area is captured by changing a position of the moving robot 100. However, aspects of the present invention are not limited thereto, and Various other techniques (e.g., Histogram of Oriented Gradient (HOG), Haar feature, Fems, Local Binary Pattern (LBP), and Modified Census Transform (MCT)) can be applied.

The learning module 143 may classify at least one descriptor of each acquisition image into a plurality groups based on descriptor information, obtained from an acquisition image of each position, by a predetermined subordinate classification rule and may convert descriptors in the same group into low-level descriptors by a predetermined subordinate representation rule (in this case, if only one descriptor is included in the same group, the descriptor and a subordinate representative descriptor thereof may be identical).

In another example, all descriptors obtained from acquisition images of a predetermined area, such as a room, may be classified into a plurality of groups by a predetermined subordinate classification rule, and descriptors included in the same group by the predetermined subordinate representation rule may be converted into subordinate representative descriptors.

The above descriptions about the predetermined subordinate classification rule and the predetermined subordinate representation rule may be understood through the following description about a predetermined classification rule and a predetermined representation rule. In this process, a feature distribution of each position may be obtained. A feature distribution of each position may be represented as a histogram or an n-dimensional vector.

In another example, a method for estimating an unknown current position of the moving robot 100 based on a descriptor generated from each feature without using the predetermined subordinate classification rule and the predetermined subordinate representation rule is already well-known.

The learning process includes, after the area separation process (S10) and the descriptor calculation process (S15), an area feature distribution calculation process (S20) of storing an area feature distribution calculated for each of the areas based on the plurality of descriptors by the predetermined learning rule.

The predetermined learning rule includes a predetermined classification rule for classifying the plurality of descriptors into a plurality of groups, and a predetermined representative rule for converting the descriptors included in the same group into representative descriptors. (The predetermined subordinate classification rule and the predetermined subordinate representative rule may be understood through this description)

The learning module 143 may classify a plurality of descriptors obtained from all acquisition image in each area into a plurality of groups by a predetermined classification rule (the first case), or may classify a plurality of subordinate representative descriptors calculated by the subordinate representative rule into a plurality of groups by a predetermined classification rule (the second case). In the second case, the descriptors to be classified by the predetermined classification rule is regarded as indicating the subordinate representative descriptors.

In FIG. 11, A1G1, A1G2, A1G3, . . . , A1GI illustrates groups into which all descriptors in an area A1 are classified by a predetermined classification rule. In the square bracket [ ], there is shown at least one descriptor classified into the same group. For example, descriptors classified into a group A1G1 are \vec{F1},\vec{F4},\vec{F7}. The remaining groups of A1G2, A1G3, . . . , A1GI are expressed in the same way and thus detailed description thereof is herein omitted.

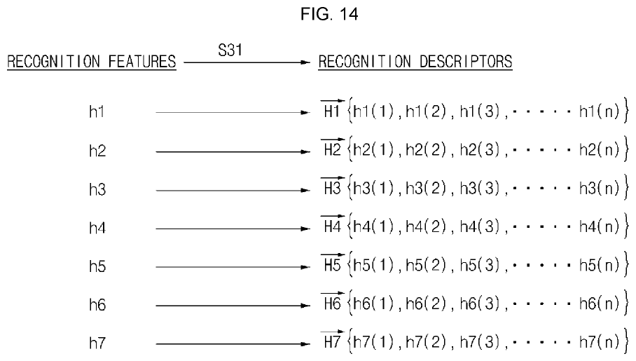

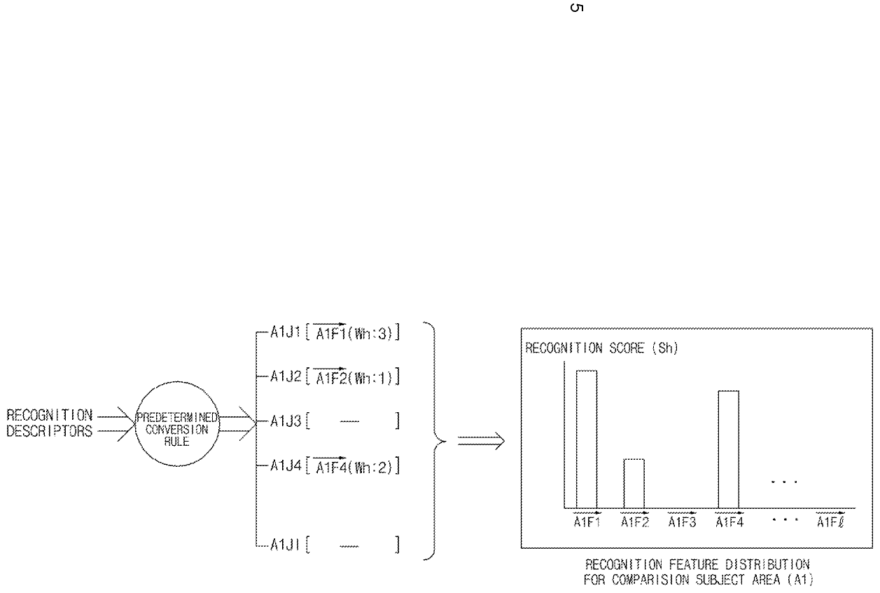

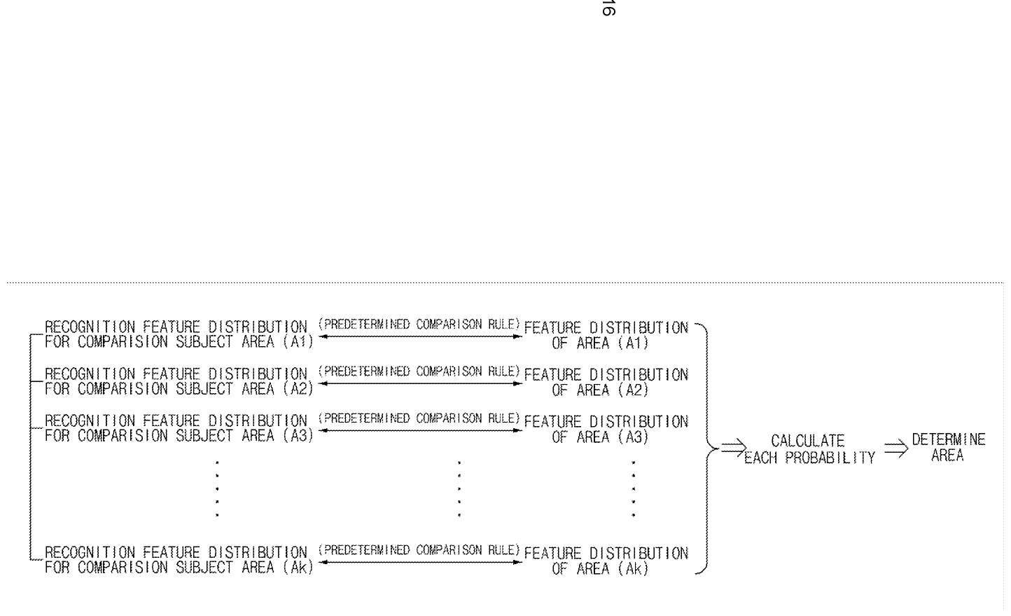

Referring to FIG. 11, the learning module 143 converts descriptors included in the same group into representative descriptors by the predetermined representation rule. In FIG. 14, \vec{A1F1}, \vec{A1F2}, \vec{A1F3}, . . . , \vec{A1Fl} are representative descriptors converted by the predetermined representation rule. A plurality of descriptors included in the same group is converted into the identical representative descriptors. For example, \vec{F1},\vec{F4},\vec{F7} included in a group A1G1 are all converted into \vec{A1F1}. That is, the three different descriptors \vec{F1},\vec{F4},\vec{F7} included in the group A1G1 are converted into three identical representative descriptors (\vec{A1F1},\vec{A1F1},\vec{A1F1}). Conversion of descriptors included in other groups A1G2, A1G3, . . . , and A1GI are performed in the same way, and thus, detailed description thereof is herein omitted.

The predetermined classification rule may be based on a distance between two n-dimensional vectors. For example, descriptors (n-dimensional vectors) having a distance between the n-dimensional vectors being equal to or smaller than a predetermined value ST1 may be classified into the same group, and Equation 1 for classifying two n-dimensional vectors \vec{A},\vec{B} into the same group may be defined as in Equation 1 as below.

d=|\vec{A}−\vec{B}|≤ST1 Equation 1

Here, \vec{A},\vec{B} is two n-dimensional vectors,

d is a distance between the two n-dimensional vectors, and

ST is a predetermined value.

The predetermined representation rule may be based on an average of at least one descriptor (n-dimensional vector) classified into the same group. For example, when it is assumed that descriptors (n-dimensional vectors) classified into any one group are \vec{A1}, \vec{A2}, \vec{A3}, . . . , \vec{Ax} wherein x is the number of the descriptors classified into the group, a representative descriptor (n-dimensional vector) \vec{A}. may be defined as in Equation 2 as below.

$$\vec{A} = \frac{\vec{A 1} + \vec{A 2} + \vec{A 3} + … + \vec{Ax}}{x} \qquad Equation 2$$

Types of representative descriptors converted by the predetermined classification rule and the predetermined representation rule, and the number (weight w) of representative descriptors per type are converted into data in units of zones. For example, the area feature distribution for each of the areas (e.g., A1) may be calculated based on the type of the representative descriptors and the number w of representative descriptors per type. Using all acquisition image acquired in any one area, types of all representative descriptors in the area and the number w of representative descriptors per type may be calculated. An area feature distribution may be represented by a histogram, where types of representative descriptors are representative values (values on the horizontal axis) and scores s increasing in disproportion to the number w of representative descriptors per type are frequencies (values on the vertical axis). (See FIG. 12) For example, a score sl of a particular representative descriptor may be determined as the number (a total weight w of a corresponding area) of all representative descriptors calculated in the corresponding area (a feature distribution of which is desired to obtain) corresponding to a weight w1 of the particular representative descriptor.

$$s 1 = \frac{\sum w}{w 1} \qquad Equation 3$$

Here, s1 is a score of a representative descriptor,

w1 is a weight of the representative descriptor, and

Σw is a total sum of all representative descriptors calculated in a corresponding area.

The above Equation 3 assigns a greater score s to a representative descriptor calculated by a rare feature so that, when the rare feature exists in an acquisition image at an unknown current position described later on, an area in which an actual position is included may be estimated more accurately.

An area feature distribution histogram may be represented by an area feature distribution vector which regards each representative value (representative descriptor) as each dimension and a frequency (score s) of each representative value as a value of each dimension. Area feature distribution vectors respectively corresponding to a plurality of areas A1, A2, . . . , and Ak on a map may be calculated. (k is a natural number)

Next, the following is description a process of estimating an area, in which a current position is included, based on data such as each pre-stored area feature distribution vector and estimating the current position based on data such as the pre-stored descriptor or subordinate representative descriptor when the current position of the moving robot 100 becomes unknown due to position jumping and the like.

The recognition process includes a recognition descriptor calculation process S31 of acquiring an image at the current position, extracting the at least one recognition feature from the acquired image, and calculating the recognition descriptor corresponding to the recognition feature.

The moving robot 100 acquires an acquisition image an unknown current position through the image acquisition unit 120. The recognition module 144 extracts the at least one recognition feature from an image acquired at the unknown current position. The drawing in FIG. 13 illustrates an image captured at the unknown current position, in which various features such as lighting devices, edges, corners, blobs, ridges, etc. located at a ceiling are found. Through the image, a plurality of recognition features h1, h2, h3, h4, h5, h6, and h7 located at the ceiling is found.

The “recognition feature” is a term used to describe a process performed by the recognition module 144, and defined differently from the term “feature” used to describe a process performed by the learning module 143, but these are merely terms defined to describe characteristics of a world outside the moving robot 100.

The recognition module 144 detects features from an acquisition image. Descriptions about various methods for detecting features from an image in computer vision and various feature detectors suitable for feature detection are the same as described above.

Referring to FIG. 21, for such feature detection, the recognition module 144 calculates recognition descriptors respectively corresponding to recognition features h1, h2, h3, . . . , and hn using the SIFT. The recognition descriptors may be represented as n-dimensional vectors. In FIG. 21, \vec{H1}, \vec{H2}, \vec{H3}, . . . , \vec{H7}. indicate dimensional vectors. h1(1), h1(2), h1(3), . . . , h1(n) within the brace { } of \vec{H1} indicate values of respective dimensions of \vec{H1}. The remaining \vec{H1} are represented in the same way and thus detailed description thereof is herein omitted.

After the recognition descriptor calculation process S31, the recognition process includes an area determination process S33 for computing each area feature distribution and the recognition descriptor by the predetermined estimation rule to determine an area in which the current position is included. Throughout this description, the term “compute” means calculating an input value (one input value or a plurality of input values) by a predetermined rule. For example, when calculation is performed by the predetermined estimation rule by regarding the small feature distributions and/or the recognition descriptors as two input values, this may be expressed such that the small area feature distributions and/or recognition descriptor are “computed”.

The predetermined estimation rule includes a predetermined conversion rule for calculation of a recognition feature distribution, which is comparable with the small feature distribution, based on the at least one recognition descriptor. Throughout this description, the term “comparable” means a state in which a predetermined rule for comparison with any one subject is applicable. For example, in the case where there are two sets consisting of objects with a variety of colors, when colors of objects in one of the two sets are classified by a color classification standard of the other set in order to compare the number of each color, it may be expressed that the two sets are “comparable”. In another example, in the case where there are two sets having different types and numbers of n-dimensional vectors, when n-dimensional vectors of one of the two sets are converted into n-dimensional vectors of the other sets in order to compare the number of each n-dimensional vector, it may be expressed that the two sets are “comparable”.

Referring to FIG. 15, based on information on at least one recognition descriptor acquired from the acquisition image acquired at the unknown current position Pu, the recognition module 144 converts performs conversion by a predetermined conversion rule into information (a recognition feature distribution) comparable with information on an area (e.g., each area feature distribution) which is a comparison subject. For example, the recognition module 144 may calculate a recognition feature distribution vector, which is comparable with each area feature distribution vector, based on at least one recognition descriptor by the predetermined conversion rule. Recognition descriptors are respectively converted into close representative descriptors in units of comparison subject areas through the predetermined conversion rule.

In one embodiment, with reference to each dimension (each representative descriptor) of an area feature distribution vector of an area A1 which is a comparison subject, at least one recognition descriptor may be converted into a representative descriptor having the shortest distance between vectors by a predetermined conversion rule. For example, \vec{H5} and \vec{H1} among \vec{H1}, \vec{H2}, \vec{H3}, . . . , \vec{H7} may be converted into \vec{A1F4} which is a representative descriptor having the shortest distance among representative descriptors constituting a feature distribution of a particular area.

Furthermore, when a distance between a recognition descriptor and a descriptor closest to the recognition descriptor in the predetermined conversion rule exceeds a predetermined value, conversion may be performed based on information on remaining recognition descriptors except the corresponding recognition descriptor.

When it comes to comparison with a particular comparison subject area, a recognition feature distribution for the comparison subject area may be defined based on types of the converted representative descriptors and the number (recognition weight wh) of representative descriptors per type. The recognition feature distribution for the comparison subject area may be represented as a recognition histogram, where a type of each converted representative descriptor is regarded a representative value (a value on the horizontal axis) and a recognition score sh calculated based on the number of representative descriptors per type is regarded as a frequency (a value on the vertical axis). (see FIG. 15) For example, a score sh1 of any one converted representative descriptor may be defined as a value obtained by dividing a weight wh1 of the converted representative descriptor by the number (a total recognition weight wh) of all representative descriptors converted from recognition descriptors, and this may be represented as in Equation 4 as below.

$$sh 1 = \frac{wh 1}{\sum wh} \qquad Equation 4$$

Here, sh1 is a recognition score of a converted representative descriptor,

wh1 is a recognition weight of the converted representative descriptor, and

Σwh is a total sum of recognition weights of all converted representative descriptors calculated from an acquisition image acquired at an unknown current position.

The above Equation 4 assigns a greater recognition score sh in proportion of the number of converted represented descriptors calculated based on recognition features at an unknown position, so that, when there are close recognition features existing in the acquisition image acquired at the current position, the close recognition features may be regarded as major hint to estimate an actual position and thus a current position may be estimated more accurately.

A histogram about a position comparable with an unknown current position may be represented by a recognition feature distribution vector, where each representative value (converted representative descriptor) is regarded as each dimension and a frequency of each representative value (recognition score sh) is regarded as a value of each dimension. Using this, it is possible to calculate a recognition feature distribution vector comparable with each comparison subject area.

The predetermined estimation rule includes a predetermined comparison rule for comparing each respective area feature distributions with the recognition feature distribution to calculate similarities therebetween. Referring to FIG. 16, each area feature distribution may be compared with a corresponding recognition feature distribution by the predetermined comparison rule and a similarity therebetween may be calculated. For example, a similarity between a particular area feature distribution vector and a corresponding recognition feature distribution vector (which means a recognition feature distribution vector converted by a predetermined conversion rule according to a comparison subject area to be comparable) may be defined as in Equation 5 as below. (cosine similarity)

$$cos θ = \frac{\vec{X} \cdot \vec{Y}}{\vert \vec{X} \vert \times \vert \vec{Y} \vert} \qquad Equation 5$$

Here, cos θ is a probability indicative of a similarity,

\vec{X} is an area feature distribution vector,

\vec{Y} is a recognition feature distribution vector comparable with \vec{X}.

|\vec{X}|×|\vec{Y}| indicates multiplication of absolute values of the two vectors, and

\vec{X}·\vec{Y} indicates an inner product of two vectors.

A similarity (probability) for each comparison subject area may be calculated, and a small area having the highest probability may be determined to be an area in which a current position is included.

After the area determination process S33, the recognition process includes a position determination process S35 of determining the current position among a plurality of position of the determined area.

Based on information on at least one recognition descriptor obtained from an acquisition image acquired at an unknown current position, the recognition module 144 performs conversion by a predetermined subordinate conversion rule into information (a subordinate recognition feature distribution) comparable with a position information (e.g., a feature distribution of each position) comparable with a comparison subject.

By a predetermined subordinate comparison rule, a feature distribution of each position may be compared with a corresponding recognition feature distribution to calculate a similarity therebetween. A similarity (probability) for the position corresponding to each position, and a position having the highest probability may be determined to be the current position.

The predetermined subordinate conversion rule and the predetermined subordinate comparison rule may be understood through the description about the predetermined conversion rule and the predetermined comparison rule.

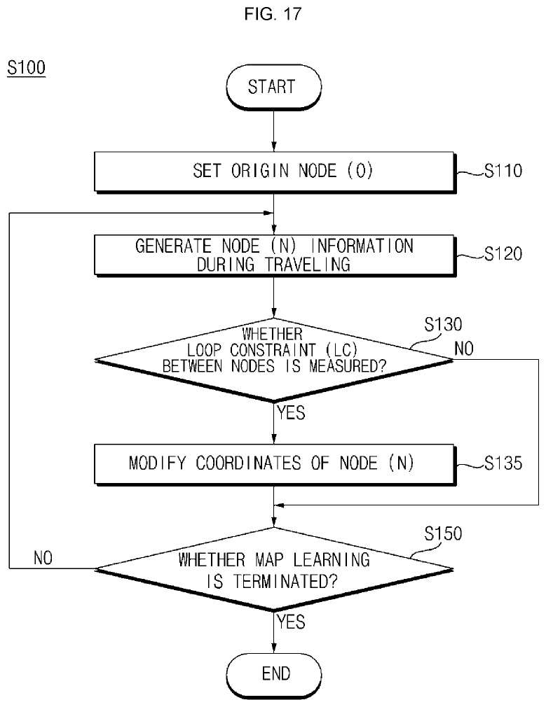

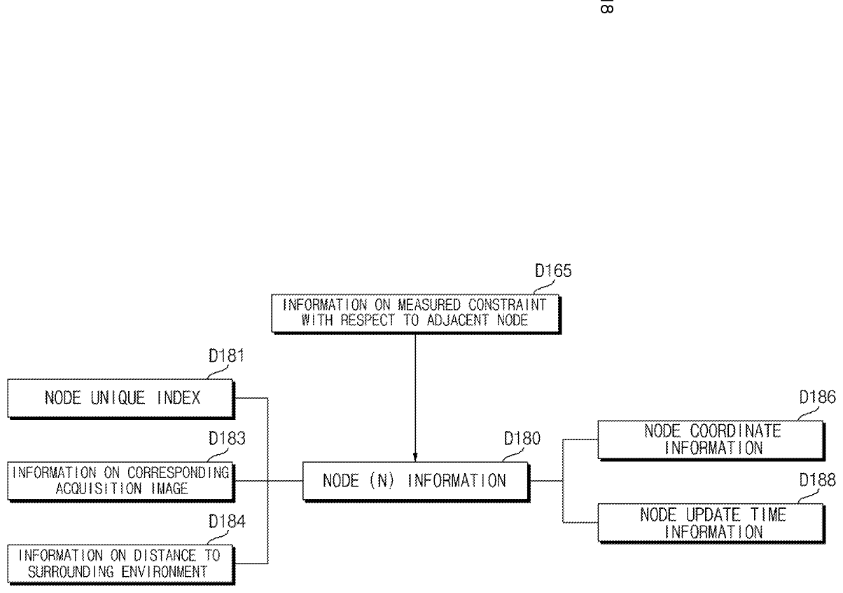

Hereinafter, with reference to FIGS. 17 to 19, there is described a learning process (S100) in which only one moving robot learns a map while traveling in a travel area X, according to a first embodiment of the present invention.

A process of learning a map by a moving robot according to the present invention is based on information D180 on a node N.

The learning process (S100) includes a process of setting an origin node O. The origin node O is a reference point on a map, and information D186 on coordinates of the node N is generated by measuring a constraint relative to the origin node O. Even when the information D186 on coordinates of the node N is changed, the origin node O is not changed.

The learning process (S100) includes a process (S120) of generating the information D180 on the node N during traveling of the moving robot 100 after the process (S110) of setting the origin node O.

Referring to FIG. 18, the information D180 on the node N includes a node unique index D181 indicating that the information D180 on a node N is information on which node out of a plurality of information D180 on nodes N. In the following description, when a plurality of moving robots transmits and receives the information D180 on the node N with each other or with a center server, it is possible to identify the information D180 on the node N, which is redundant in a plurality of information D180 on the node N, based on the node unique index D181.

In addition, the information D180 on the node N may include acquisition image information D183 corresponding to a corresponding node N. The corresponding acquisition image information D183 may be an image acquired by the image acquisition unit 125 at an actual position corresponding to the corresponding node N.

In addition, the information D180 on the node N may include information D184 on a distance to an environment in the surroundings of the corresponding node N. The information D184 on a distance to the surrounding environment may be information on a distance measured by the obstacle detection sensor 131 at the actual position corresponding to the corresponding node N.

In addition, the information D180 on the node N includes the information D186 on coordinates of the node N. The information D186 on coordinates of the node N may be obtained with reference to the origin node O.

In addition, the information D180 on the node N may include node update time information D188. The node update time information D188 is information on a time of generating or modifying the information D180 on the node N. When the moving robot 100 receives information D180 on the node N having an identical node unique index D181 as that of the existing information D180 on the node N, whether to update the information D180 on the node N may be determined based on the node update time information D188. The node update time information D188 may be used to determine whether to carry out update toward the latest information D180 on the node N.

Information D165 about a measured distance to an adjacent node means the travel constraint and information on a loop constraint (LC) which will be described later on. When the information D165 on a measured constraint with respect to an adjacent node is input to the controller 140, the information D180 on the node N may be generated or modified.

The modification of the information D180 on the node N may be modification of the information on coordinates of the node N and the node update time information D188. That is, once generated, the node unique index D181, the corresponding acquisition image information D183, and the information D184 on a distance to a surrounding environment are not modified even when the information D165 on a measured constraint with respect to an adjacent node are received, but the information D186 on coordinates of the node N and the node update time information D188 may be modified when the information D165 about a measured constraint with respect to an adjacent node is received.

In the process (S120) of generating the information D180 on the node N, when the measured travel constraint (the information D165 on a measured constraint relative to an adjacent node) is received, the information D180 on the node N may be generated based on the above. Coordinates of a node N2 at which an end point of the travel constraint is generated (node coordinate information D186) may be generated by adding the travel constraint with respect to coordinates of a node N1 at which an end point of the travel constraint is generated (node coordinate information D186). With reference to a time when the information D180 on the node N is generated, the node update time information D188 is generated. At this point, a node unique index D181 of the generated node N2 is generated. In addition, information D183 on an acquisition image corresponding to the generated node N2 may match with the corresponding node N2. In addition, information D184 on a distance to a surrounding environment of the generated node N2 may match with the corresponding node N2.

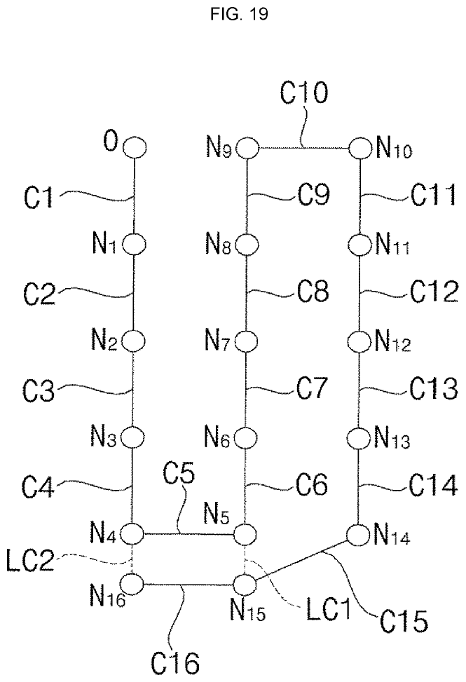

Referring to FIG. 19, the process (S120) of generating information D180 on a node N is as follows: information D180 on a node N1 is generated in response to reception of a travel constraint C1 measured when the origin node O is set, information D180 on a node N2 is generated in response to reception of a travel constraint C2 when the information D180 on the node N1 is already generated, and information D180 on a node N3 is generated in response to reception of a travel constraint C3 when the information D180 on the node N2 is already generated. Based on travel constraints C1, C2, C3, . . . , and C16 received sequentially, node information D180 on nodes N1, N2, N3, . . . , N16 may be generated sequentially.

The learning process (S100) includes, after the process (S120) of generating the information D180 on the node N during traveling, a process (S130) of determining whether to measure a loop constraint between nodes N. In the process (S130) of determining whether to measure a loop constraint LC between the nodes N, when the loop constraint LC is measured, a process (S135) of modifying the information on coordinates of the node N is performed, and, when the loop constraint LC is not measured, a process (S150) of determining whether to terminate map learning of the moving robot 100 is performed. In the map learning termination determination process (S150), when the map learning is not terminated, the process (S120) of generating the information on the node N during traveling may be performed again. FIG. 17 illustrates one embodiment, and the process (S120) of generating the information on the node N during traveling and the process (S130) of determining whether measure a loop constraint LC may be performed in reverse order or may be performed at the same time.

Referring to FIG. 19, when a node C15 at which a travel constraint C15 starts is defined as a “basic node” of a node 16 which is an end point of the travel constraint C15, a loop constraint LC indicates a measurement of a constraint between a node N15 and a node N5 which is not the “basic node N14” of the node N15, but a node N5 adjacent to the node N15.

For example, by comparing acquisition image information D183 corresponding to the node N15 and acquisition image information D183 corresponding to the adjacent node N5, a loop constraint LC between two nodes N15 and N5 may be measured. In another example, by comparing distance information D184 of the node N15 and distance information D184 of the adjacent node N5, a loop constraint LC between the two nodes N15 and N5 may be measured.

FIG. 19 exemplarily illustrates a loop constraint LC1 measured between a node N5 and a node N15, and a loop constraint LC2 measured between a node N4 and a node N!6.

For convenience of explanation, two nodes N with reference to which a loop constraint LC is measured are defined a first loop node and a second loop node, respectively. An “outcome constraint (Δx1,Δy1,θ1)” calculated based on pre-stored coordinate information D186 of the first loop node and coordinate information D186 of the second loop node (calculated based on difference between coordinates) may lead to a difference (Δx1−Δx2,Δy1−Δy2,θ1−θ2) from a loop constraint LC (Δx2,Δy2,θ2). If such difference occurs, the node coordinate information D186 may be modified by regarding the difference as an error, the node coordinate information D186 is modified in the premise that the loop constraint LC is a more accurate value than the outcome constraint.

When the node coordinate information D186 is modified, only the node coordinate information D186 of the first loop node and the second loop node may be modified: however, since the error occurs as errors of travel constraints has been accumulated, it may be set such that the error is distributed to modify node coordinate information D186 of other nodes. For example, the node coordinate information D186 may be modified by distributing the error value to all nodes that are generated by the travel constraint between the first loop node and the second loop node. Referring to FIG. 19, when a loop constraint LC1 is measured and the error is outcome, the error is distributed to nodes N6 to N14 including the first loop node N15 and the second loop node N5, and therefore, node coordinate information D186 of all the nodes N5 to N15 may be modified a little. Of course, by expanding error distribution, node coordinate information D186 of nodes N1 to N4 may be modified together.

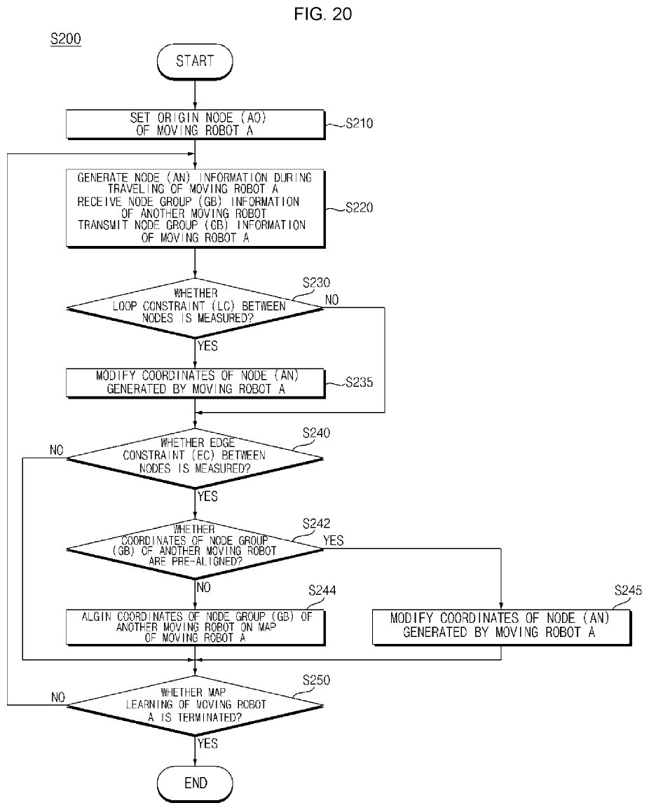

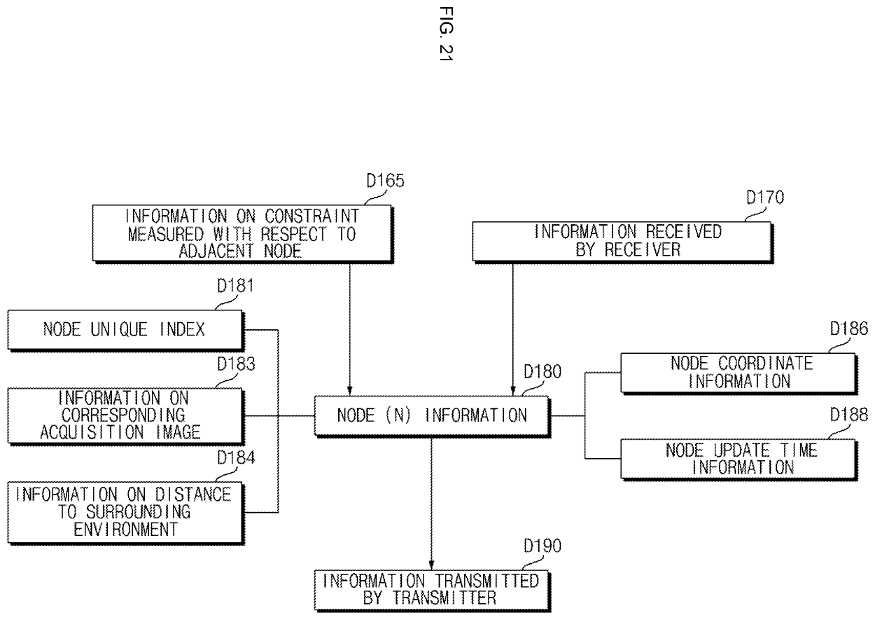

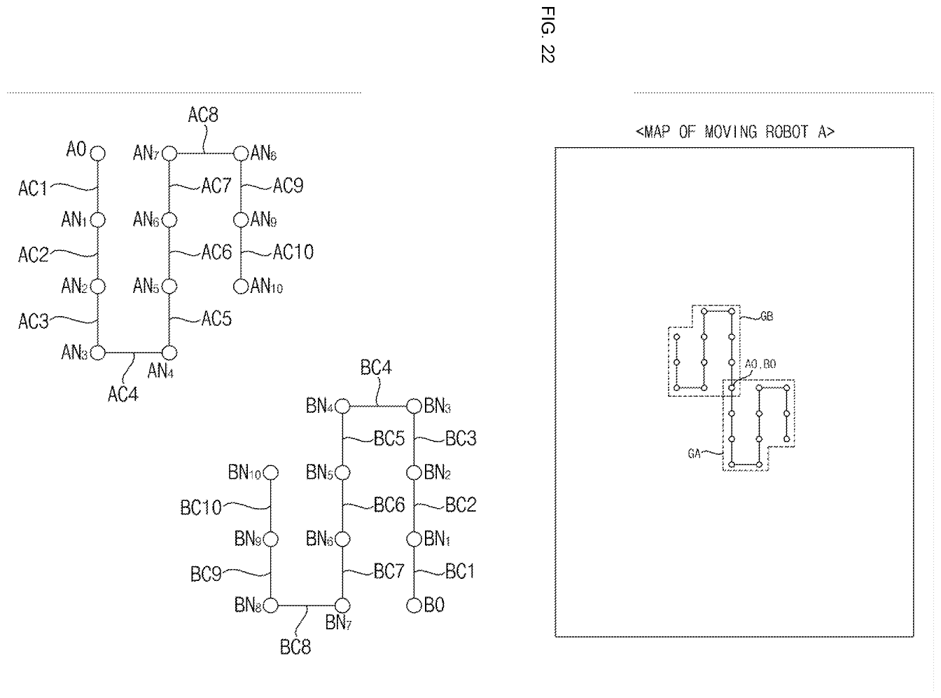

Hereinafter, with reference to FIGS. 20 to 24, there is described a learning process (S200) in which a plurality of moving robot learns a map in corporation with each other while traveling in a travel area X, according to a second embodiment. Hereinafter, a redundant description of the second embodiment with the first embodiment is omitted.

The learning process (S200) is described with reference to a moving robot A out of a plurality of moving robots. That is, in the following description, a moving robot A 100 indicates a moving robot 100. Another moving robot 100 may be a plurality of moving robots, but, in FIGS. 20 to 24, for convenience of explanation, another moving robot is described is only one unit as a moving robot B 100, but aspects of the present invention are not limited thereto.

The learning process (S200) includes a process (S210) of setting an origin node AO of the moving robot 100. The origin node AO is a reference point on a map, and generated by measuring a constraint of the moving robot 100 relative to the origin node AO. Even when information D186 on coordinates of a node AN is modified, the origin node AO is not changed. However, an origin node BO of another moving robot 100 is information received by the receiver 190 of the moving robot 100 and not a reference point on a map being learned by the moving robot 100, and the origin node BO may be regarded as information on the node N, which can be generated and modified/aligned.

After the process (S110) of setting the origin node AO, the learning process (S100) includes a process (S220) of generating information D180 on a node N during traveling of the moving robot 100, receiving node group information of another moving robot 100 through the receiver 190, and transmitting node group information of the moving robot 100 through the transmitter 170 to another moving robot.

Node group information of a moving robot may be defined as a set of all node information D180 stored in the moving robot, except node information D180 generated by the moving robot. In addition, the node group information of another moving robot is defined as a set of all node information D180 stored in another moving robot, except node information D180 generated by another moving robot.

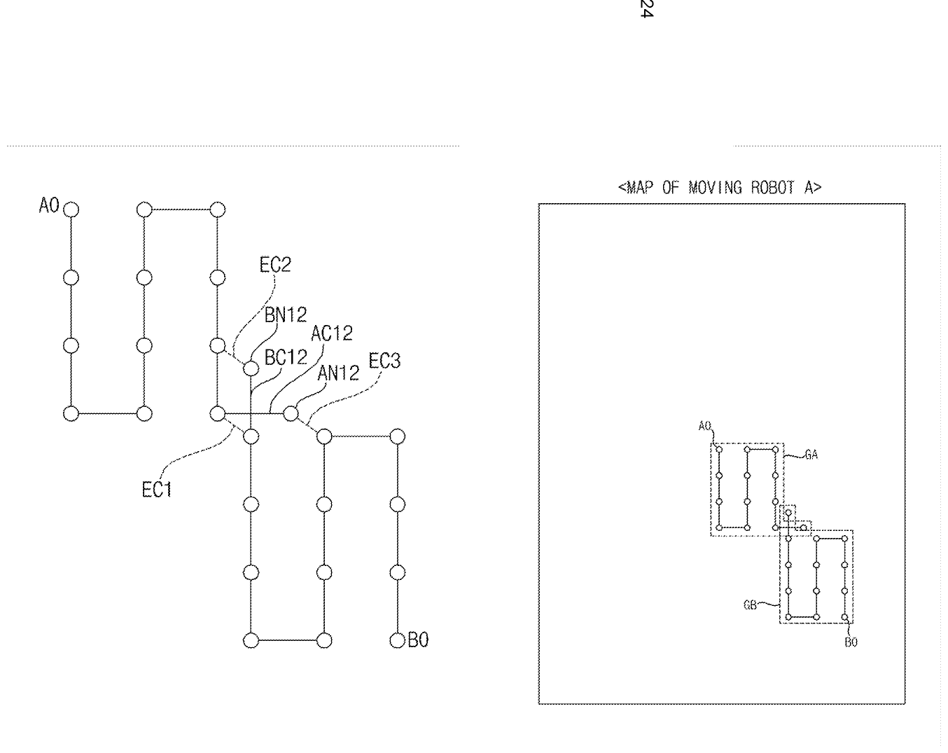

In FIGS. 22 to 24, as for a moving robot A, node group information of a moving robot B means information D180 on nodes in an area indicated by GB, and, as for the moving robot B, node group information of the moving robot A means information D180 on nodes in an area indicated by GA. In addition, in FIG. 25, as for the moving robot A, the node group information on the moving robot B means node group information means information D180 on nodes areas indicated by GB and BC (when the moving robot B has received information on nodes in the area GC from the moving robot A or C), and, as for the moving robot A, node group information of the moving robot C means information D180 on nodes in an area indicated by GB and GC (when the moving robot C has received information on nodes in the area GB from the moving robot A or B).

On the contrary, node group information of a moving robot may be defined as a set of node information “generated” by the moving robot. For example, referring to FIG. 25, as for the moving robot A, the node group information of the moving robot C may be information on nodes in the area GC and may be set to be received only from the moving robot C.

Referring to FIG. 21, the information D180 on the node N may include the node unique index D181, the image acquisition information D183 corresponding to the corresponding to the node N, the information D184 on a distance to a surrounding environment of the corresponding node N, the information D186 on coordinates of the node N, and the node update time information D188. Detailed description thereof is the same as described above.

Transmitter transmission information D190 means information on a node N, which is generated or modified by the moving robot, transmitted to another moving robot. Transmitter transmission information D190 of the moving robot may be node group information of the moving robot.

Receiver reception information D170 means information on a node N, which is generated or modified by another moving robot, received from another moving robot. Transmitter reception information D170 of the moving robot may be node group information of another moving robot. Receiver reception information D170 may be added to pre-stored node information D180, or update existing node information D180.

Description about a process of generating the information D180 on the node N during traveling of the moving robot 100 is the same as the description about the first embodiment.

Referring to FIG. 21, information D165 on a measured constraint relative to an adjacent node means the travel constraint information, the information on a loop constraint (LC), and information on an edge constraint (EC) which will be described later on. When the information D165 on a measured constraint relative to an adjacent node is input to the controller 140, the information D180 on the node N may be generated or modified.

Modification of the information D180 on the node N may be modification of information on coordinates of the node N and node update time information D188. That is, once generated, the node unique index 181, the corresponding acquisition image information D183, and the information D184 on a distance relative to a surrounding environment are not modified even when the information D165 on a measurement constraint relative to an adjacent node is received, but, the information D186 on coordinates of the node N and the node update time information D188 may be modified when the information D165 on a measured constraint relative to an adjacent node is received.

Referring to FIGS. 22 to 24, information on nodes N on a map of the moving robot 100 is comprised of node information D180 GA generated by the moving robot 100 and node group information GB of another moving robot 100.

In the process (S220), node information of each moving robot is generated based on a constraint measured during traveling of a plurality of moving robot.

Referring to FIGS. 22 to 24, the process (S220) of generating the information D180 on the node AN by the moving robot 100 is as follows: information D180 on a node AN1 is generated in response to reception of a travel constraint AC1 measured when the origin node AO is set, information D180 on a node AN2 is generated in response to reception of a travel constraint AC2 when information on D180 on the node AN1 is already generated, and information D180 on a node AN3 is generated in response to reception of a travel constraint when the information D180 on the node AN2 is already generated. Based on travel constraints AC1, AC2, AC3, . . . , and AC12 received sequentially, node information D180 on nodes AN1, AN2, AN3, . . . , and AN12 are received sequentially.

The process (S220) of generating the information D180 on the node AN by another moving robot 100 is as follows: information D180 on a node BN1 is generated in response to reception of a travel constraint BC1 measured when the origin node BO is set, and then node information D180 of nodes BN1, BN2, BN3, . . . , and BN12 is generated sequentially based on travel constraints BC1, BC2, BC3, . . . , and BC12 received sequentially.

In the process (S220), a plurality of moving robots transmits and receives node group information with each other.

Referring to FIGS. 22 to 24, the moving robot 10 receives node group information BN of another moving robot, and adds node group information GB of another moving robot on a map of the moving robot 100. In FIG. 22, when an edge constraint EC between the moving robot 100 and another moving robot 100 has yet to be measured, a position of the origin node BO of another robot 100 may be randomly located on the map of the moving robot 100. In this embodiment, the origin node BO of another moving robot 100 on the map of the moving robot 100 is set to be located at a position identical to a position of the origin node AO of the moving robot 100 on the map of the moving robot 100. Until the node group information of another moving robot 100 is modified on the map as the edge constraint EC is measured, node information GA generated by the moving robot and node group information GB of another moving robot are combined, and thus, it is difficult to generate a map matching with the current situation.

The moving robot 100 transmits the node group information GA of the moving robot 100 to another moving robot. The node group information GA of the moving robot is added to a map of another moving robot 100.

The learning process (S200) includes a process (S230) of determining whether to measure a loop constraint LC between two nodes generated by the moving robot. The learning process (S200) may include a process of measuring a loop constraint LC between two nodes generated by the moving robot.

Description about the loop constraint LC is the same as the description about the first embodiment.

The learning process (S200) may include a process (S245) of modifying coordinates of a node, generated by the moving robot, on the map of the moving robot based on the measured loop constraint LC.

The process (S230) of determining whether to measure a loop constraint LC between nodes AN includes: a process (S235) of modifying coordinate information of nodes AN generated by a plurality of moving robots is performed when the loop constraint LC is measured; and a process (240) of determining whether to measure an edge constraint EC between a node generated by the moving robot and a node generated by another moving robot when the loop constraint LC is not measured. The learning process (S200) may include a process of measuring an edge constraint between a node generated by the moving robot and a node generated by another moving robot. The learning process (S200) may include a process of measuring an edge constraint EC between two nodes generated by a plurality of moving robots.

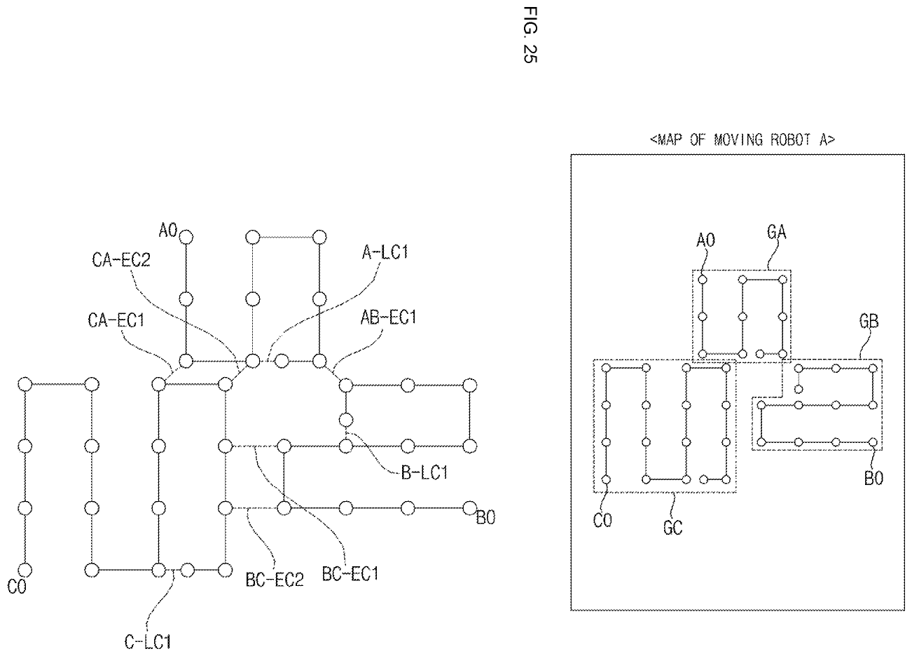

Referring to FIGS. 23 and 24, an edge constraint EC is a measurement of a constraint between a node AN!1 generated by a moving robot and a node BN11 generated by another moving robot.

For example, as acquisition image information D183 corresponding to the node AN11 generated by the moving robot and acquisition image information D183 corresponding to a node BN11 generated by another moving robot are compared, an edge constraint EC1 between the two nodes AN11 and BN11 may be measured. In another example, as distance information D184 of the nod AN11 generated by the moving robot and distance information D184 on the node BN11 generated by another moving robot are compared, the edge constraint EC1 between the two nodes AN11 and BN11 may be measured.

Measurement of such an edge constraint EC is performed by each moving robot, and node group information generated by another moving robot may be received from another moving robot through the receiver 190, and, it is possible to compare its own generated node information with the received node group information generated by another moving robot.

In FIGS. 23 and 24, the edge constraint EC1 measured between the node AN11 and the node BN11, an edge constraint EC2 measured between a node AN 12 and a node BN4, and an edge EC3 measured between a node AN10 and a node BN12 are illustrated exemplarily.

If the edge constraint EC is not measured in the process (240) of determining whether to measure an edge constraint, a process (S250) of determining whether to terminate map learning of the moving robot 100 is performed. If the map learning is not terminated in the map learning termination determination process (S250), a process (S220) of generating information on a node N during traveling and transmitting and receiving node group information by a plurality of moving robots may be performed. FIG. 20 shows merely an embodiment, and the process (S120) of generating information on a node N during traveling and transmitting and receiving node group information, the process (S130) of determining whether to measure a loop constraint LC between nodes, and the process (S240) of determining whether to measure an edge constraint EC between nodes may be performed in different order or may be performed at the same time.

If the edge constraint EC is measured in the process (S240) of determining whether to measure the edge constraint EC, a process (S242) of determining whether coordinates of a node group GB received from another moving robot is pre-aligned on a map of the moving robot 100 is performed,

The alignment means that node group information GA of the moving robot and node group information GB of another moving root are aligned similarly with actual alignment on the map of the moving robot based on the edge constraint EC. That is, the edge constraint EC provides a hint to fit the node group information GA of the moving robot and the node group information GB of another moving robot, which are like puzzle pieces. The alignment is performed in a manner as follows: on the map of the moving robot, coordinates of the origin node BO of another moving robot is modified in the node group information GB of another moving robot, and coordinates of a node BN of another moving robot is modified with reference to the modified coordinates of the origin node BO of another moving robot.

Referring to FIG. 23, if the node group GB of another moving robot is not pre-aligned on the map of the moving robot in the process (S242), a process (S244) of aligning coordinates of a node group GB received from the other moving robot (another moving robot) on a map of one moving robot (the moving robot) is performed. At the same time, a process (S244) of aligning coordinates of a node group GA received from one moving robot (the moving robot) on a map of the other moving robot (another moving robot) is performed. In FIG. 23, unlike FIG. 22, it is found that the node group information GB of another moving robot entirely moves and aligned on the map of the moving robot.

Information on an edge constraint EC1 between nodes generated by two moving robot may be transmitted to both of the two moving robots, and thus, one moving robot is capable of aligning node group information of the other moving robot with reference to itself on a map of the corresponding moving robot.

Referring to FIG. 24, when coordinates of a node group GB received from another moving robot is pre-aligned on the map of the moving robot in the process (S242), a process (S245) of modifying coordinates of a node generated by one moving robot (the moving robot) on a map of one moving robot (the moving robot) based on measured edge constraints EC2 and EC3 is performed. At the same time, a process (S245) of modifying coordinates of a node generated by the other moving robot (another moving robot) on a map of the one another moving robot is performed.

Information on the edge constraints EC2 and EC3 measured between two nodes generated by two moving robots is transmitted to both of the two moving robots, and each moving robot is capable of modifying its own generated node information on its map there with reference to itself.

For convenience of explanation, a node generated by the moving robot out of two nodes for which an edge constraint is measured is defined as an edge node, and a node generated by another moving robot is defined as another edge node. An “outcome variable” (outcome based on difference between coordinates) outcome based on pre-stored node coordinate information D186 of a main edge node and node coordinate information D186 of another edge node may have difference from an edge constraint. When such difference occurs, it the node coordinate information D186 generated by the moving robot may be modified by regarding the difference as an error, and the node coordinate information D186 is modified in the premise that the edge constraint EC is a more accurate value than the outcome variable.

When the node coordinate information D186 is modified, only the node coordinate information D186 of the main edge node may be modified: however, since the error occurs as errors of travel constraint has been accumulated, it may set such that the error is distributed to modify even node coordinate information D186 of other nodes generated by the moving robot. For example, the node coordinate information D186 may be modified by distributing the error to all nodes generated by a travel constraint between two main edge nodes (which occurs when an edge constraints is measured two or more times). Referring to FIG. 24, when an edge constraint EC3 is measured and the error is outcome, the error may be distributed to a node AC11 including the main edge node AN12 and another main edge node AN10, node coordinate information D186 of the nodes AN 10 to AN 12 may be modified a little. Of course, by expanding the error distribution, the node coordinate information D186 of nodes AN1 to AN12 may be modified together.

The learning process (S200) may include: a process of aligning coordinates of a node group received from the other moving robot (another moving robot) on a map of one moving robot (the moving robot) based on the measured edge constraint EC; and a process of aligning coordinates of a node group received from one moving robot (the moving robot) on a map of the other moving robot (another moving robot).

The learning process (S200) may include: a process of modifying coordinates of a node generated by one moving robot (the moving robot) on the map of one moving robot (the moving robot) based on the measured edge constraint EC; and a process of modifying coordinates of a node generated by the other moving robot (another moving robot) on the map of the other moving robot (another moving robot).

After the processes (S244) and (S245), a process (S250) of determining whether to terminate map leaning of the moving robot 100 may be performed. If the map learning is not terminated in the map learning termination determination process (S250), the process of generating information on a node N during traveling and transmitting and receiving node group information with each other by a plurality of moving robot may be performed again.

Referring to FIG. 25, the description about the second embodiment may apply even when there are three or more moving robots.

When the plurality of moving robots is three or more moving robots, node group information received by a first moving robot from a second moving robot may include node group information received by the second moving robot from a third moving robot. In this case, when node information received from the same node (e.g., node information generated by the third moving robot rom the second moving robot) and stored node information (e.g., node information generated by the third moving robot, which is already received from the third moving robot) are different, the latest node information may be selected based on the node update time information to determine whether to update node information.

FIG. 25 exemplarily illustrates a loop constraint A-LC1 measured between two nodes generated by a moving robot A, a loop constraint B-LC1 measured between two nodes generated by a moving robot B, and a loop constraint C-LC1 measured between two nodes generated by a moving robot C. In addition, FIG. 25 exemplarily illustrates a edge constraint AB-EC1 measured between a node generated by the moving robot A and a node generated by the moving robot B, two edge constraints BC-EC1 and BC-EC2 measured between a node generated by the moving robot B and a node generated by the moving robot C, and two edge constraints CA-EC1 and CA-EC2 measured between a node generated by the moving robot C and a node generated by the moving robot A.

FIG. 25 illustrates that information on nodes generated by the moving robot A on a map of the moving robot A, and node group information of another moving robot which is aligned through the edge constraint.

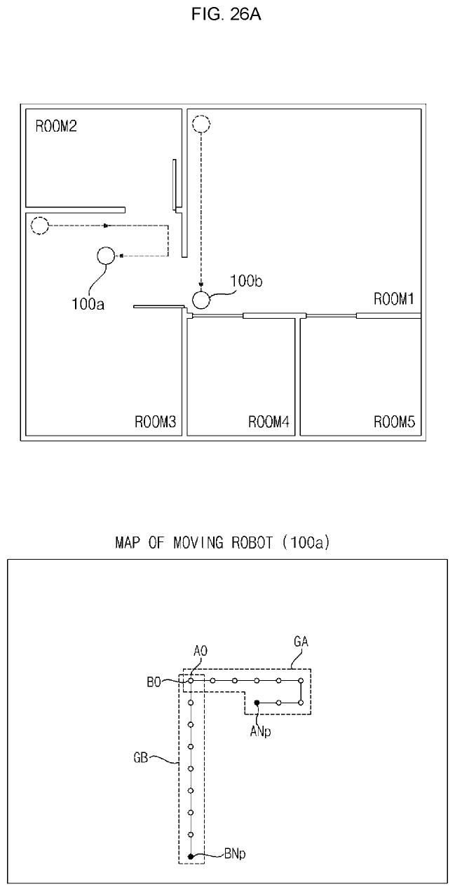

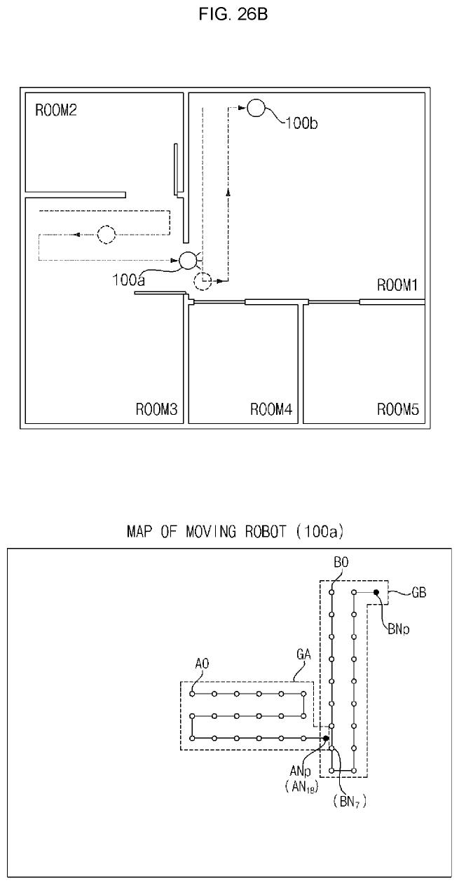

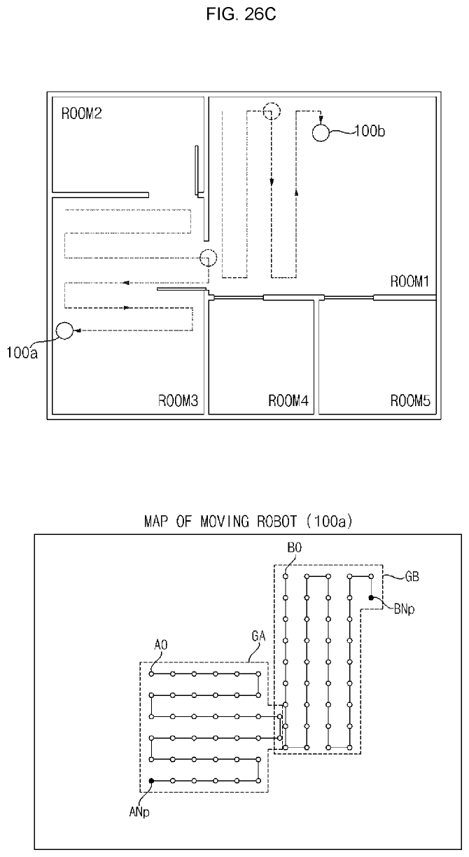

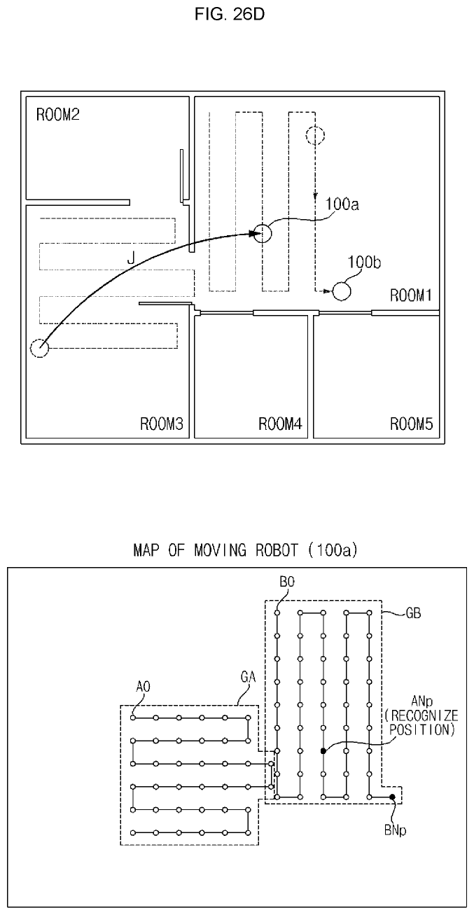

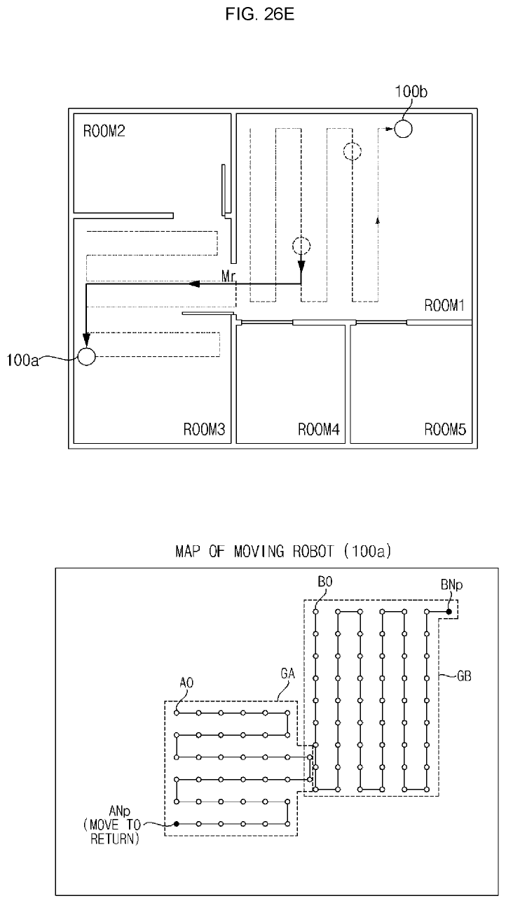

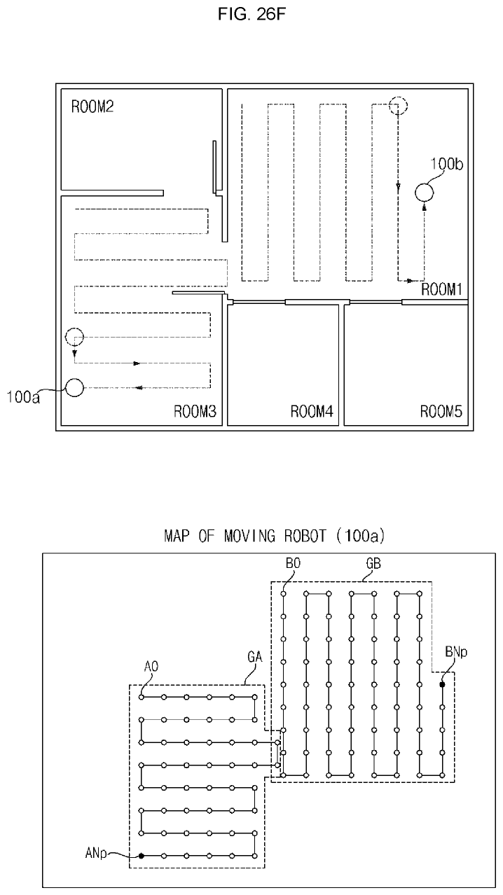

Referring to FIGS. 26A to 26, there is hereinafter described a scenario of generating a map by a moving robot 100a and another moving robot 100b in corporation and utilizing the generated map.

A condition of the scenario shown in FIGS. 26A to 26F is as follows. There are five rooms Room1, Room2, Room3, Room4, and Room5 on an actual plan. On the actual plan, the moving robot 100a is positioned in Room 3, and another moving robot 100b is positioned in Room 1. Now, a door between Room1 and Room 4 is closed, a door between Room1 and Room5 is closed, and thus, the moving robots 100a and 100b is not allowed to move from Room1 to Room4 on its own. In addition, a door between Room1 and Room3 is now opened, and thus, the moving robots 100a and 100b is allowed to move from one of Room1 and Room3 to the other one. The moving robots 100a and 100b have not learned the actual plan, and it is assumed that traveling shown in FIGS. 26A to 26F is the first travel on the actual plan.

In FIGS. 26A to 26F, information on nodes (N) on a map of the moving robot 100a is comprised of node information D180 GA generated by the moving robot 100a, and node group information GB of another moving robot 100b. A node ANp displayed as a block dot among nodes on the map of the moving robot 100a indicates a node corresponding to the actual current position of the moving robot 100a. In addition, a node BNp displayed as a block dot among modes on the map of the moving robot 100a indicates a node corresponding to the actual current position of another moving robot 100b.

Referring to FIG. 26A, when the origin node AO corresponding to a first actual position of the moving robot 100 is set, the moving robot 100 sequentially generates information on a plurality of nodes based on a travel constraint measured during traveling. At the same time, when an origin node BO corresponding to an actual current position of another moving robot 100b is set, another moving robot 100b sequentially generates information on a plurality of nodes based on a travel constraint measured during traveling. The moving robot generates node group information GA on the map by itself. At the same time, although not illustrated, another moving robot generates information on a node group GB on the map of another moving robot by itself. In addition, the moving robot and another moving robot transmit and receive node group information with each other, and accordingly, the information on the node group GB may be added to the map of the moving robot. In FIG. 26A, an edge constraint has not been measured, and node group the information GA and the information on the node group GB are merged in the assumption that the origin node AO and the origin node BO coincides with each other on the map of the moving robot. In this case, a relative position relationship between a node in the node group information GA and a node in the information on the node group GB on the map of the moving robot does not reflect an actual position relationship.

Referring to FIG. 26B, after the above, the moving robot and another moving robot constantly perform traveling and learning. An edge constraint EC between a node AN18 in the node group information GA and a node BN7 in the node group information GB is measured. As coordinates of nodes in the information on the node group GB are modified based on an edge constraint on the map of the moving robot, the node group information GA and the node group information GB are aligned. In this case, a relative position relationship between a node in the node group information GA and a node in the node group information GB on the map of the moving robot in FIG. 26B does not reflect an actual position relationship. In addition, the moving robot is able to map an area traveled by another moving robot even if the moving robot itself does not travel in the area traveled by another moving robot.

Referring to FIG. 26C, after coordinates of the node group information GB on the map of the moving robot are aligned, the moving robot performs learning while continuously traveling in Room 3, and hence, node information is added to the node group information GA. In addition, another moving robot performs learning while continuously traveling in Room1, and hence, node information is added to the node group information and another moving robot transmits the updated node group information GB to the moving robot. Accordingly, node information is added to the node group information GA and the node group information GB on the map of the moving robot. In addition, as an edge constraint and a loop constraint are measured additionally, the node information of the node group information GA and the node group information GB are constantly modified.

Referring to FIG. 26D, after the above, the moving robot in move is picked up by a user or the like to move from Room3 to Room1. (See arrow J). A position of a point into which the moving robot moves is any one node in the node group information. The moving robot recognizes a current position ANp on the map of the moving robot.

Referring to FIG. 26F, after the above, the moving robot moves to a destination position using the map of the moving robot. (Arrow Mr) In this scenario, the moving robot moves to Room3 where the moving robot originally traveled. Although not illustrated, in another scenario, in order to clean Room1 together with another moving robot, the moving robot moves to an area, which has not been traveled by another moving robot in Room1, and then perform cleaning travel. Even when the moving robot is moving to a destination position, another moving robot performs learning while continuously traveling in Room1, and accordingly, node information is added to the node group information GB and another moving robot transmits the updated node group information GB to the moving robot. Accordingly, node information is constantly added to the node group information GB on the map of the moving robot.

Referring to FIG. 26F, after the moving robot moves to a destination position, the moving robot resume cleaning ravel in an area not yet to be cleaned in Room 3, and performs learning. In addition, another moving robot performs learning while continuously traveling in Room1, and accordingly, node information is added to the node group information GB and another moving robot transmits the updated node group information GB to the moving robot. Accordingly, node information is added to the node group information GA and the node group information GB on the map of the moving robot. In addition, as an additional loop constraint is measured, the node information of the node group information GA and the node group information GB is constantly modified.

The moving robot 100 according to the second embodiment of the present invention includes a travel drive unit 160 for moving a main body 110, a travel constraint measurement 121 for measuring a travel constraint, a receiver 190 for receiving node group information of another moving robot, and a controller 140 for generating node information on a map based on the travel constraint and adding the node group information of another moving robot to the map. Any description redundant with the above description is herein omitted.

The moving robot 100 may include a transmitter 170 which transmits node group information of a moving robot to another moving robot.

The controller 140 may include a node information modification module 143b which modifies coordinates of a node generated by the moving robot on the map based on the loop constraint LC or the edge constraint EC measured between two nodes.

The controller 140 may include a node group coordinate alignment module 143c which aligns coordinates of a node group generated from another moving robot on the map based on the edge constraint EC measured between a node generated by the moving robot and a node generated by another moving robot.

When coordinates of a node group received from another moving robot on a map is pre-aligned, the node information modification module 143b may modify coordinates of a node generated by the moving robot on the map based on the measured edge constraint EC.

A system for a plurality of moving robots 100 according to the second embodiment of the present invention includes a first moving robot and a second moving robot.

The first moving robot 100 includes a first drive unit for moving the first moving robot, a first travel constraint measurement unit 121 for measuring a travel constraint of the first moving robot, a first receiver 190 for receiving node group information of the second moving robot, a first transmitter 170 for transmitting node group information of the first moving robot to the second moving robot, and a first controller 140. The first controller 140 generates node information on a first map generated by the first moving robot based on the travel constraint of the first moving robot, and adds the node group information of the second moving robot to the first map.

The second moving robot 100 includes a second travel drive unit 160 for moving the second moving robot, a second travel constraint measurement unit 121 for measuring a travel constraint of the second moving robot, a second receiver 190 for receiving node group information of the first moving robot, a second transmitter 170 for transmitting node group information of the second moving robot to the second moving robot, and a second controller 140. The second controller 140 generates node information on a second map generated by the second moving robot based on the travel constraint of the second moving robot, and adds the node group information of the first moving robot to the second map.

The first controller may include a first node information modification module 143b which modifies coordinates of a node generated by the first moving robot on the first map based on the loop constraint LC or the edge constraint EC measured between two nodes.

The second controller may include a second node information modification module 143b which modifies coordinates of a node generated by the second moving robot on the second map based on the loop constraint LC or the edge constraint EC.

The first controller may include a first node group coordinate alignment module 143c which aligns coordinates of a node group received from the second moving robot on the first map based on an edge constraint LC measured between a node generated by the first moving robot and a node generated by the second moving robot.

The second controller may include a second node group coordinate alignment module 143c which aligns coordinates of a node group received from the first moving robot on the second map based on the edge constraint LC.

What is claimed is:

1. A map learning method of a moving robot, comprising:
generating, by the moving robot, node information based on a constraint measured during traveling; and
receiving node group information of another moving robot.

2. The map learning method of claim 1, further comprising transmitting node group information of the moving robot to the another moving robot.

3. The map learning method of claim 1, further comprising:
measuring a loop constraint between two nodes generated by the moving robot; and
modifying coordinates of the nodes, generated by the moving robot, on a map based on the measured loop constraint.

4. The map learning method of claim 1, further comprising:
measuring an edge constraint between a node generated by the moving robot and a node generated by the another moving robot; and
aligning coordinates of a node group, received from the another moving robot, on a map based on the measured edge constraint.

5. The map learning process of claim 1, further comprising:
measuring an edge constraint between a node generated by the moving robot and a node generated by the another moving robot; and
modifying coordinates of the node generated by the moving robot on a map based on the measured edge constraint.

6. The map learning method of claim 1, further comprising:
measuring an edge constraint between a node generated by the moving robot and a node generated by the another moving robot; and
when coordinates of a node group received from the another moving robot is not pre-aligned on a map, aligning the coordinates of the node group received from the another moving robot on the map based on the measured edge constraint, and, when the coordinates of the node group received from the another moving robot is pre-aligned on the map, modifying the coordinates of the node generated by the moving robot on the map based on the measured edge constraint.

7. A map learning method, comprising:
generating, by a plurality of moving robots, node information of each of the plurality of moving robots based on constraint measured during traveling; and
transmitting and receiving node group information of each of the plurality of moving robots with one another.

8. The map learning method of claim 7, further comprising:
measuring an edge constraint between two nodes respectively generated by the plurality of moving robots; and
aligning coordinates of a node group received from the other moving robot on a map of one moving robot based on the measured edge constraint, and aligning coordinates of a node group received from one moving robot on a map of the other moving robot based on the measured edge constraint.

9. The map learning method of claim 7, further comprising:
measuring an edge constraint between two nodes respectively generated by the plurality of moving robots; and
modifying coordinates of a node generated by one moving robot on a map of one moving robot based on the measured edge constraint, and modifying coordinates of a node generated by the other moving robot on a map of the other moving robot based on the measured edge constraint.

10. The map learning method of claim 7, further comprising:
measuring an edge constraint between two nodes respectively generated by the plurality of moving robots;
when coordinates of a node group received from the other moving robot is not pre-aligned on a map, aligning coordinates of a node group received from the other moving robot on a map of one moving robot based on the measured edge constraint and aligning coordinates of a node group received from one moving robot on a map of the other moving robot based on the measured edge constraint; and
when the coordinates of the node group received from the other moving robot is pre-aligned on the map, modifying coordinates of a node generated by one moving robot on the map of one moving robot based on the measured edge constraint and modifying coordinates of a node generated by the other moving robot on the map of the other moving robot based on the measured edge constraint.

11. The map learning method of claim 7,
wherein the node group information comprises information on each node,
wherein the information on each node comprises node update time information, and
wherein, when received node information and stored node information are different with respect to an identical node, latest node information is selected based on the node update time information.

12. The map learning method of claim 11,
wherein the plurality of moving robot is three or more moving robots, and
wherein node group information received by a first moving robot from a second moving robot comprises node group information received by the second moving robot from a third moving robot.

13. A moving robot comprising:
a travel drive unit configured to move a main body;
a travel constraint measurement unit configured to measure a travel constraint;
a receiver configured to receive node group information of another moving robot; and
a controller configured to generate node information on a map based the travel constraint, and add the node group information of the another moving robot to the map.

14. The moving robot of claim 13, further comprising a transmitter configured to transmit node group information of the moving robot to the another moving robot.

15. The moving robot of claim 13, wherein the controller comprises a node information modification module configured to modify coordinates of a node generated by the moving robot on the map based on a loop constraint or an edge constraint measured between two nodes.

16. The moving robot of claim 13, wherein the controller comprises a node group coordinate alignment module configured to align coordinates of a node group received from the another moving robot on the map based on an edge constraint measured between a node generated by the moving robot and a node generated by the another moving robot.

17. The moving robot of claim 16, wherein the controller comprises a node information modification module configured to, when the coordinates of the node group received from the another moving robot is pre-aligned on the map, modify coordinates of the node generated by the moving robot on the map based on the measured edge constraint.

18. A system for a plurality of moving robots comprising a first moving robot and a second moving robot,
wherein the first moving robot comprises:
a first travel drive unit configured to move the first moving robot;
a first travel constraint measurement unit configured to measure a travel constraint of the first moving robot;
a first receiver configured to receive node group information of the second moving robot;
a first transmitter configured to transmit node group information of the first moving robot to the second moving robot; and
a first controller configured to generate node information on a first map based on the travel constraint of the first moving robot, and add the node group information of the second moving robot to the first map, and
wherein the second moving robot comprises:
a second travel drive unit configured to move the second moving robot;
a second travel constraint measurement unit configured to measure a travel constraint of the second moving robot;
a second receiver configured to receive the node group information of the first moving robot;
a second transmitter configured to transmit the node group information of the second moving robot to the second moving robot; and
a second controller configured to generate node information to a second map based on the travel constraint of the second moving robot, and add the node group information of the first moving robot to the second map.

19. The system of claim 18,
wherein the first controller comprises a first node information modification module configured to modify coordinates of a node generated by the first moving robot on the first map based on a loop constraint or an edge constraint measured between two nodes, and
wherein the second controller comprises a second node information modification module configured to modify coordinates of a node generated by the second moving robot on the second map based on the loop constraint or the edge constraint.

20. The system of claim 18,
wherein the first controller comprises a first node group coordinate alignment module configured to align coordinates of a node group received from the second moving robot on the first map based on an edge constraint measured between a node generated by the first moving robot and a node generated by the second moving robot, and
wherein the second controller comprises a second node group coordinate alignment module configured to align coordinates of a node group received from the first moving robot on the second map based on the edge constraint.
